(19) United States
(12) Patent Application Publication
(10) Pub. No.: US 2026/0048549 A1
(43) Pub. Date: Feb. 19, 2026

(54) SPACER FABRICS ANALOGOUS STRUCTURES AND PRODUCTION TECHNIQUES THEREOF

(71) Applicant: TECHNION RESEARCH & DEVELOPMENT FOUNDATION LIMITED, Haifa (IL)

(72) Inventor: Yoav STERMAN, Haifa (IL)

(21) Appl. No.: 19/100,491

(22) PCT Filed: Aug. 1, 2023
(86) PCT No.: PCT/IL2023/050796

§ 371 Date: Jan. 31, 2025

Related U.S. Application Data
(60) Provisional application No. 63/370,054, filed on Aug. 1, 2022.

(51) Int. Cl. B29C 64/386; B29C 64/118; B33Y 10/00; B33Y 50/00; B33Y 80/00

(52) U.S. Cl. CPC B29C 64/386; B29C 64/118; B33Y 10/00; B33Y 50/00; B33Y 80/00

(57) ABSTRACT

A multilayered structure is disclosed comprising an alternating stack of one or more wavy layer patterns and one or more flipped wavy layer patterns stacked one on top of the other, to thereby form between anterior and posterior sides of the multilayered structure a plurality of “X”-shaped connections and a plurality of holes in anterior and posterior sides of the multilayered structure.

### TECHNOLOGICAL FIELD

The present application is generally in the field of metamaterials, particularly printed three-dimensional (3D) metamaterials, such as spacer fabrics.

### BACKGROUND ART

References considered to be relevant as background to the presently disclosed subject matter are listed below:
[1] Lea Albaugh, James McCann, Scott E Hudson, and Lining Yao. 2021. Engineering Multifunctional Spacer Fabrics Through Machine Knitting. Proceedings of the 2021 CHI Conference on Human Factors in Computing Systems, 1-12.
[2] Jonathan Bunyan, Sameh Tawfick, S Tawfick, and J Bunyan. 2019. Exploiting Structural Instability to Design Architected Materials Having Essentially Nonlinear Stiffness. Advanced Engineering Materials 21, 2: 1800791.
[3] Jack Forman, Mustafa Doga Dogan, Hamilton Forsythe, and Hiroshi Ishii. 2020. DefeXtiles: 3D Printing Quasi-Woven Fabric via Under-Extrusion.
[4] Andrew Gleadall. 2021. FullControl GCode Designer: Open-source software for unconstrained design in additive manufacturing. Additive Manufacturing 46, September 2020: 102109.
[5] Jared Kastner, Amin Joodaky, and James Gibert. 2021. The effectiveness of 2d unit cells in creating ξ-spring based metamaterials. Proceedings of ASME 2021 Conference on Smart Materials, Adaptive Structures and Intelligent Systems, SMASIS 2021: 1-9.
[6] S. Koda and H. Tanaka. 2017. Direct G-code manipulation for 3D material weaving. Nanosensors, Biosensors, Info-Tech Sensors and 3D Systems 2017 10167, May 2017: 1016719.
[7] Kumar, A., Verma, S., & Jeng, J. Y. (2020). Supportless lattice structures for energy absorption fabricated by fused deposition modeling. 3D Printing and Additive Manufacturing, 7(2), 85-96.
[8] Yanping Liu, Hong Hu, Li Zhao, and Hairu Long. Compression behavior of warp-knitted spacer fabrics for cushioning applications. Textile Research Journal 82, 1: 11-20.
[9] Lingyun Sun, Jiaji Li, Mingming Li, et al. 3DP-Ori: Bridging-Printing Based Origami Fabrication Method with Modifiable Haptic properties; 3DP-Ori: Bridging-Printing Based Origami Fabrication Method with Modifiable Haptic properties.
[10] Joanne Yip and Sun Pui Ng. 2008. Study of three-dimensional spacer fabrics: Physical and mechanical properties. Journal of Materials Processing Technology 206, 1-3: 359-364.

### BACKGROUND

This section intends to provide background information concerning the present application, which is not necessarily prior art.

Spacer fabrics are three-dimensional knitted structures made of two separate layers of fabric attached together during a knitting process by a filler yarn. The filler yarn is usually semi-stiff and knitted orthogonally to the two surface faces layers while connecting them and maintaining a fixed distance between them (FIG. 1A). The structure of spacer fabrics provides ventilation, energy absorption and has a soft, elastic quality. Thanks to this diverse set of features, spacer fabrics are commonly used in a variety of products such as shoes, protective pads, upholstery, bags, and sound products.

Generally, spacer fabrics are knitted as flat sheets using double-needle bar warp knitting machines, although it is also possible to produce spacer fabric by weft knitting machines (see e.g., [1]). These machines tend to be large and expensive, and the knitting process requires a lengthy setup and a skilled operator. These techniques can produce spacer fabrics with a range of thicknesses, densities, and materials. Yet, they are limited in their ability to modulate these parameters within a single knitted fabric. This limitation hinders customization and bespoke fabrication that is essential in many emerging applications.

### Knitted Spacer Fabrics

Knitted spacer fabrics have a variety of applications ranging from architecture and automotive vehicles interiors, soft robotics, protective equipment, and intimate apparel (see e.g., [10]). The mechanical and physical properties of knitted spacer fabrics were investigated for their sound adsorbate capabilities, thermal conductivity, and cushioning properties. As an energy absorbent material, spacer fabrics are used as a replacement for rubber and foam materials. A study by Liu et al. examined how the manufacturing parameters of knitted spacer fabric affect the compression behavior of the material (see [8]). In that study, spacer fabrics with different filler yarn thickness and inclination angles, as well as material thickness and texture of the surface faces, were tested to inspect changes in compression behavior.

### TPU-Based 3D Printed Metamaterials Lattice Structures

Thermoplastic polyurethane (TPU) is a flexible material suitable for 3D printing using fused deposition modeling (FDM) technology. This material is used widely to design metamaterials structures, which are materials with a microstructure that affect the properties of the material. Various 3D printed lattice TPU structures printed on FDM machines have been tested for their compression properties. Kumar et al. presented a TPU structure inspired by the shape of sea urchin with a good absorption capacity of energy, that is 3D printed without supports (see [7]). While avoiding using supports shortens the printing time compared to printing with soluble supports, the printing process is still relatively slow given the volume of the parts. This is in part due to the many starts and stops in the printer's toolpath. The above examples of 3D printed TPU structures utilize the standard FDM workflow of designing a 3D geometry then slicing it using a standard slicing software.

A more relevant example of mechanical compressive structures is 2D unit cells that generate X-springs. The compression behavior of X-spring cells is an essential nonlinear stiffness that is usually a characteristic of foams. This is due to the bucking of the strut elements that are connected at the center of the shape (see e.g., [7]). Kastner et al. (see [5]) investigated 3D printed tessellations of these units using TPU to achieve this compression behavior in two orthogonal loading directions.

### 3D Printed Fabrics on FDM 3D Printers

Few projects have demonstrated 3D printing textile-line structures on an FDM 3D printer for examples weaved structures (see e.g., [9]). Another example is DefeXtiles (see e.g., [3]), a 3D printed tulle-like fabric with different levels of transparencies that are achieved by the under-extrusion of materials during printing.

### G-Code Manipulation

Standard FDM 3D printing workflow includes transforming a 3D model into slices using a slicing software. The slicing software calculates the toolpath of each slice based on user selections, then outputs a g-code file. The g-code file is fed into the 3D printer that follows the toolpath to produce the original model. Several other projects used the FullControl G-Code Designer open-source software, that is based on spreadsheets, to design objects allowing full control over the g-code parameters (see e.g., [4]). G-code manipulation was used to create textures onto 3D models and vary the stiffness and inner structures of 3D models (see e.g., [6]).

### GENERAL DESCRIPTION

The spacer fabrics commonly used nowadays are three-dimensional fabrics composed of two knitted fabrics and a filler yarn that is knitted orthogonally between them. These spacer fabrics are favorable thanks to their soft, breathable, and elastic properties. Indeed, they are prevalent in a variety of products such as bags, footwear, and protective equipment. Spacer fabrics are usually knitted on large and expensive double-needle bar warp knitting machines. These machines can produce spacer fabrics in a variety of thicknesses, patterns, and densities. However, they are limited in their potential to change these parameters within a single knitted fabric.

The present application discloses nonuniform spacer fabric analogous structures. It is however noted that the embodiments disclosed herein can be similarly used to design and manufacture uniform 3D multilayered structures that are substantially similar to the conventional knitted spacer fabrics available nowadays. In a broad aspect, new metamaterial 3D extruded/printed structures and techniques are provided, that are inspired and resemble conventional spacer fabric structures. These metamaterial 3D extruded/printed structures/techniques, which are also referred to herein as 3D multilayered structures, and in some embodiments as 3D Printed Spacer Fabrics (3DSF), can potentially contribute to a new class of lightweight 3D printed/extruded compression materials, that can be produced on-demand using low-cost equipment and engineered to provide specific compression requirements. For example, in possible embodiments, the 3D multilayered structures are produced using desktop 3D printer(s) and of-the-shelf thermoplastic polyurethane (TPU) filament(s). The 3D multilayered structures disclosed herein can be handled like a conventionally knitted spacer fabric structure. It can be sewn onto other fabrics and washed in a washing machine.

The design tools/procedures disclosed herein enable controlling different geometry and printing parameters of the 3D multilayered structures of the present application. In order to evaluate how the different parameters affect the compression behavior, a series of compression tests were conducted using an Instron machine. The results demonstrate the differences in the compression behavior that indicate that 3D multilayered structures of the present application can be tuned to fit specific applications. The following case studies were used to illustrate the advantages and usage of the 3D multilayered structures/techniques disclosed herein:
(i) biker shorts;
(ii) a kneepad that uses the disclosed 3DSF for padding;
(iii) insoles;
(iv) midsole; and
(v) bra.

In other aspects, new techniques are disclosed for manufacture of customizable and non-uniform (or uniform) spacer fabric analogous structures. 3D extruding/printing is utilized in some embodiments with newly developed slicing technique, workflow, and design tool for, generating printable metamaterial structures (generally referred to herein as 3D multilayered structures), that are inspired by and resembles conventional spacer fabrics. A unique feature of embodiments disclosed herein, that enables efficient fabrication, is that the 3D multilayered structures of the present application are not printed lying down, but in an up-right/standing position i.e., the 3D layered structures are constructed in a bottom-to-top, or a top-to-bottom process. The 3D multilayered structures obtained utilizing the production techniques disclosed herein are flexible, breathable, lightweight, and exhibit fabric-like qualities that, in some cases, are similar to the conventionally knitted spacer fabrics.

Moreover, using the 3D multilayered structures production techniques of the present application, it is possible to produce structures that are challenging to produce by the conventional knitting techniques, such as, for example, spacer fabrics analogous structures with a large distance between the face surfaces. In addition, the 3D multilayered structures production techniques of the present application enable variable thickness of the final structure and of its spacer strands, variable inclination angles of the filler strands, and allow multiple densities and stiffnesses across the extruded/printed 3D multilayered structures. Furthermore, the final fabric product obtained by the 3D multilayered structures and techniques disclosed herein are not limited to flat 2D sheets; indeed, it is possible to generate 3D curved geometries and complex surface patterns. Finally, the 3D multilayered structures disclosed herein can be handled like any other textile: it can be cut with scissors, sewn, and washed in a washing machine.

Unlike the standard manufacturing process, that requires specialized machinery, and depends on long supply chains for providing the yarns, the 3D multilayered structures production techniques of the present application enable extruding/printing spacer fabrics on unmodified, low-cost desktop 3D Fused Deposition Modeling (FDM) printers, for example. A single material is used in some embodiments e.g., an off-the-shelf 95A shore Thermoplastic Polyurethane (TPU) filament, for printing both the inner strands and outer faces of the 3D multilayered structure (see e.g., FIG. 1B). The design tool disclosed herein generates toolpath curves that are translated into g-code lines. This toolpath leverages the bridging technique.

Bridging is a term that describes extruding/printing in mid-air by drawing material between posts. This is a common method for 3D printing overhang geometries without supports. In embodiments disclosed herein the bridging creates holes in the outer faces and generates the inner strands that give the printed part its compression qualities. In possible embodiments of this process, every layer extruded/printed structure is composed of a single continuous path, and the motion between the layers is optimized to minimize travel. This makes the printing approach highly efficient and the parts lightweight. The properties of the 3D multilayered structures of the present application can be changed parametrically without any hardware modification. By using the design tool disclosed herein, a user can change the strands' inclination angle, the thickness of the fabric, the density and thickness of the inner strands, and the hole sizes and hole patterns on the outer faces.

The 3D multilayered structures/techniques are demonstrated herein with a variety of geometry and printing parameters, that enable tuning with high flexibility the mechanical and functional properties of the 3D multilayered structures production process of the present application. The present disclosure also evaluates how these parameters affect the compression behavior of the material with a series of mechanical tests.

The embodiments disclosed herein can potentially contribute to a new class of lightweight 3D printed compression materials that can be engineered with a wide range of mechanical properties. These lightweight 3D extruded/printed compression materials can be produced on-demand using low-cost equipment and can be engineered to answer specific compression requirements.

In one aspect the present disclosure is directed to a multilayered structure comprising a plurality of wavy patterned layers stacked one on top of the other and alternatingly flipped one with respect to the other (i.e., 180° shift of the wavy pattern between he layers), to thereby form between anterior and posterior sides of the multilayered structure a plurality of “X”-shaped connections between each adjacently located pair of the plurality of wavy layer patterns in the metamaterial structure. Each one of the plurality of wavy layers comprises in some embodiments one or more wavy-shaped strands stacked one on top of the other and extending along a length of the metamaterial structure to form a plurality of holes in its anterior and posterior sides. The wavy layer patterns can be configured to form a plurality of connections between adjacently located pairs of the wavy layer patterns at the anterior and posterior sides of the multilayered structure.

Geometrical dimensions of the holes formed in the anterior and posterior sides of the multilayered structure can be controllably adjusted by forming stacks of defined number(s) of the wavy layer patterns of the same wavy shape/pattern formed one on top of the other to form a uniform three-dimensional structure, and alternately flipping stacks of the wavy layers formed one on top of the other (i.e., 180° shift between the stacks of wavy layer patterns).

In a broad aspect, there is provide a multilayered structure comprising an alternating stack of one or more wavy layer patterns and one or more flipped wavy layer patterns stacked one on top of the other, to thereby form between anterior and posterior sides of the multilayered structure a plurality of “X”-shaped connections and a plurality of holes in anterior and posterior sides of the multilayered structure. The wavy layer patterns can be configured to form a plurality of connections between adjacently located pairs of the wavy layer patterns and of the of the flipped wavy layer patterns, at the anterior and posterior sides of the multilayered structure.

Optionally, but in some embodiments preferably, each of the plurality of wavy layers is formed by a concatenation of a plurality of alternating trapezoidal structures/patterns configured for forming a plurality of openings/holes at a small base of the trapezoidal structures/patterns. The multilayered structure can have varying inclination angles, and/or lengths, of legs of the alternating trapezoidal structures with respect to bases thereof, and/or utilize trapezoidal structures having varying size(s) of their small and/or large bases, of the wavy layer patterns. It is noted that other wavy shapes can be similarly used to form the layers of the 3D multilayered structures disclosed herein, which can be used instead, or in addition to the alternating trapezoidal wavy layer patterns. For example, and without being limiting, such 3D multilayered structures can be produced utilizing one or more of square, triangular, saw-tooth, shark-fin, shaped wavy layer patterns, or combinations thereof, with or without the trapezoidal wavy layer structures.

For example, in some embodiments the 3D multilayered structure is configured to provide a metamaterial structure that mimics a spacer fabric structure. The 3D multilayered structure can have a varying peak-to-peak difference of the wavy layer patterns, thereby defining a varying thickness of the 3D multilayered structure. For example, the varying thickness can be defined according to pixels values of a grayscale image designed to guide and manage the production process. Additionally, the one or more wavy layer patterns and the one or more flipped wavy layer patterns can be configured to provide multiple densities of the wavy layer patterns and/or stiffnesses of the 3D multilayered structure thereacross e.g., by controllably changing extrusion/pultrusion thicknesses and/or frequency of the wavy layer patterns.

In some embodiments the one or more wavy layer patterns and the one or more flipped wavy layer patterns are formed by a continuous uninterrupted draw of a curable material, and/or by extrusion or pultrusion, and/or by 3D printing. If 3D printed, the 3D printer can be configured for mid-air upright standing position printing of the 3D multilayered structure.

In another aspect there is provided a system for preparing the multilayered structure according to any one of the embodiments disclosed herein, the system comprising a 3D extruder or printer, and a computer system comprising one or more processors and memories configured to generate instructions for operating the 3D extruder or printer for preparing the multilayered structure based at least in part on one or more of the following: surface geometry data; product's specifications data; thickness data; and/or stiffness data. Optionally, but in some embodiments preferably, the system comprises a 3D scanner configured to generate surface data of a target surface area to which the multilayered structure is configured to fit.

The system comprises in some embodiments one or more of the following modules: a geometry data module configured to determine geometry data of the multilayered structure based at least partially on the product's specifications data; a comparator module configured to compare between the surface data from the 3D scanner and the geometry data from the geometry data module and generate comparison data indicative thereof; a perforation module configured to determine openings'/holes' properties data of the plurality of opening/holes based at least partially on the comparison data from the comparator module, the geometry data from the geometry data module, the surface data from the 3D scanner, and/or the products' specifications data; a thickness/stiffness module configured to determine thickness/stiffness properties data of regions of the multilayered structure based at least partially on the comparison data from the comparator module, the geometry data from the geometry data module, the surface data from the 3D scanner, the products' specifications data, and/or the openings'/holes' properties data from the perforation module; a toolpath module configured to determine trajectory data of an extrusion/print nozzle of the 3D extrusion/printing system based at least partially on the comparison data from the comparator module, the geometry data from the geometry data module, the surface data from the 3D scanner, the products' specifications data, the opening's/holes' properties data from the perforation module, and/or the thickness/stiffness properties data from the thickness/stiffness module; a speed amount module configured to determine nozzle speeds data and/or amounts of materials data for each draw of material the one or more wavy layer patterns and the one or more flipped wavy layer patterns of the 3D multilayered structure based at least partially on the comparison data from the comparator module, the geometry data from the geometry data module, the surface data from the 3D scanner, the products' specifications data, the openings'/holes' properties data from the perforation module, the thickness/stiffness properties data from the thickness/stiffness module, and/or toolpath module configured to determine trajectory data; and/or a production tool instructions module configured to generate instructions data for operating the 3D extrusion/printing system for fabricating the multilayered structure based at least partially on the comparison data from the comparator module, the geometry data from the geometry data module, the surface data from the 3D scanner, the products' specifications data, the holes' properties data from the perforation module, the thickness/stiffness properties data from the thickness/stiffness module, toolpath module configured to determine trajectory data, and/or the speeds data and/or amounts of materials from the data speed amount module.

In another aspect the present disclosure is directed to a method for forming a spacer fabric analogous structure. The method comprises in some embodiments defining a plurality of curves along a desired mesh geometry, offsetting a copy of the plurality of curves a predefined distance and removing segments of the plurality of curves and their offset copy to form alternating gaps therein, manipulating remaining segments of the curves and adding connection lines for connecting each edge of the segments with an adjacently located edge of a nearby and oppositely located segment, to thereby form a plurality of wavy layer patterns, and generating instruction for a 3D extruder or printer for drawing a curable material according to the plurality of wavy layer patterns for fabrication of the spacer fabric analogous structure.

The method comprising in some embodiments forming X-shaped connection areas between the connection lines of adjacently located wavy layer patterns. The extruding can be carried out by 3D printing the plurality of wavy layers. The 3D extrusion of printing can include selecting between the following extrusion/printing modes: (i) forming the connection lines by nozzle movements with active printing operation; or (ii) forming the connection lines by nozzle movements without active printing operation. The method can comprise using oozing and/or stringing to form the connection lines in the mode (ii) extrusion or printing mode.

In some embodiments the method comprises selecting a base surface geometry and generating the desired mesh geometry from the selected base surface geometry. Optionally, the method comprising coloring the mesh geometry to define variable offset distances between the plurality of curves and their offset copy. For example, the method can comprise preparing a grayscale image for the coloring defining of the mesh geometry, such that the pixel values of the grayscale image defining the variable distances between the offset curves. Optionally, the defining of the curves comprises intersecting the mesh geometry with a plurality of parallel planes.

The method comprises in some embodiments segmenting each of the curves into an equal number of segments, and alternatingly removing segments in each slicing curve to from the alternating gaps therein. The alternating and removing of the segments can comply with a predefined group count value defining a height of the gaps.

The manipulation of the remaining segments comprises in some embodiment extending at least some of the remaining segments. For example, the extending of the at least some of the remaining segments is carried out in some embodiments in accordance with a desired inclination angle of the connecting lines.

The method may comprise setting the number of segments in each curve in accordance with a predefined strand density value of the spacer fabric analogous structure. The method can comprise generating the desired mesh geometry based on a 3D scan of a target surface area. The 3D scan of the target surface area can comprise one or both of a 3D contour surface scan and a measure of pressures, weights and/or loads, distributed over the target surface area.

### BRIEF DESCRIPTION OF THE DRAWINGS

In order to understand the invention and to see how it may be carried out in practice, embodiments will now be described, by way of non-limiting example only, with reference to the accompanying drawings. Features shown in the drawings are meant to be illustrative of only some embodiments of the invention, unless otherwise implicitly indicated. In the drawings like reference numerals are used to indicate corresponding parts, and in which:

FIGS. 1A and 1B respectively show a knitted spacer fabric (FIG. 1A) vs a 3D extruded/printed multilayered structure/spacer fabric (FIG. 1B, the arrow signifies the longitudinal printing direction) according to some possible embodiments;

FIG. 2 demonstrates the zigzag path that constructs the 3D extruded/printed multilayered structures (the top layer is marked in a bold line to show a single path, and the arrow signifies the vertical printing direction) according to some possible embodiments;

FIGS. 3A and 3B schematically illustrate geometry parameters of the 3D extruded/printed multilayered structures according to possible embodiments, wherein FIG. 3A is a top view showing stacking of two alternating wavy paths/layers one on top of the other and FIG. 3B shows a perspective view of a 3D extruded/printed multilayered structure made of alternatingly flipped stacks of wavy patterns/layers formed one on top of the other;

FIGS. 4A and 4B schematically illustrates extruding/printing the filler strands of the 3D extruded/printed multilayered structure (FIG. 4A) vs skipping the filler strands (FIG. 4B) to generate thin strings from the oozing out of the extruder/printer's nozzle (the printed strands are marked in red, and the travel movements are marked in cyan), according to some possible embodiments;

FIG. 5 is a schematic illustration of a 3D extruded/printed multilayered structure design process according to some possible embodiments; and

FIG. 6 is a flowchart schematically illustrating a grasshopper interface usable for preparation of 3D extruded/printed multilayered structures according to some possible embodiments;

FIG. 7 shows seven 3D extruded/printed swatch multilayered structures according to possible embodiments, that were printed for the compression tests, and an additional swatch that was cut from a knitted spacer fabric sheet (bottom right—Swatch #8), wherein a top view of the multilayered structures is provided in the bottom right corner showing X-spring structures of each swatch;

FIGS. 8A and 8B show the test setup of the INSTRON Electroplus E10000 machine used for compression tests of 3D extruded/printed multilayered structures according to possible embodiments;

FIG. 9 illustrates phases of the compression behavior of the X-spring shape of 3D extruded/printed multilayered structures according to some possible embodiments;

FIG. 10 shows a comparison of a conventionally knitted spacer fabric vs a 3D extruded/printed multilayered structure spacer fabric according to some possible embodiments;

FIG. 11 shows effects of strand thickness in 3D extruded/printed multilayered structures according to some possible embodiments;

FIG. 12 shows effect of inclination angle in 3D extruded/printed multilayered structures according to some possible embodiments;

FIG. 13 shows effect of layer group count on the compression behavior of 3D extruded/printed multilayered structures according to some possible embodiments;

FIGS. 14A to 14C show use of the 3D extruded/printed multilayered structure/techniques according to possible embodiments for preparation of riding shorts printed with a support structure on a desktop 3D printer (FIG. 14A), which support structure is then cut away, and the shaped piece is manually sawn to the pants fabric (FIG. 14B), which is then ready to be used (FIG. 14C);

FIGS. 15A to 15C show a CAD model of a kneepad made of a 3D extruded/printed multilayered structure according to some possible embodiments, wherein a grayscale map image as such as shown in FIG. 15A is used to generate variable thicknesses of the kneepad, the toolpath curves seen in FIG. 15B generate the visualization of the model;

FIG. 16A to 16C show use of the 3D extruded/printed multilayered structure according to some possible embodiments to 3D-print the shaped kneepad seen in FIG. 16A), which elastic straps are sewn as depicted in FIG. 16B using a sewing machine, and the morphology of the kneepad is curved to fit the shape of the knee as seen in FIG. 16C;

FIGS. 17A to 17E show use of the 3D extruded/printed multilayered structure according to some possible embodiments to 3D-print an insole as depicted in FIGS. 17A to 17D, and a midsole as depicted in FIG. 17E;

FIGS. 18A and 18B demonstrates an insole production technique utilizing 3D extruded/printed multilayered structure according to some possible embodiments;

FIG. 19 shows use of the 3D extrusion/printed multilayered structure according to possible embodiments to 3D-print a bra;

FIG. 20 is a flow chart demonstrating an article production process according to possible embodiments; and

FIG. 21 schematically illustrates a 3D multilayered structures production system according to possible embodiments.

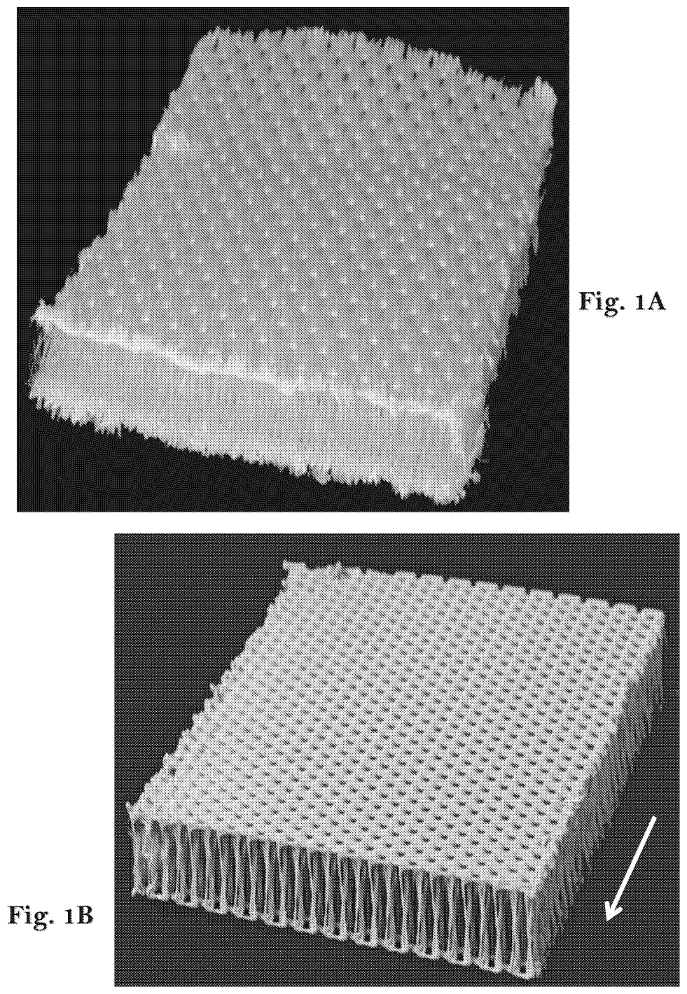

### DETAILED DESCRIPTION OF EMBODIMENTS

One or more specific and/or alternative embodiments of the present disclosure will be described below with reference to the drawings, which are to be considered in all aspects as illustrative only and not restrictive in any manner. It shall be apparent to one skilled in the art that these embodiments may be practiced without such specific details. In an effort to provide a concise description of these embodiments, not all features or details of an actual implementation are described at length in the specification. Elements illustrated in the drawings are not necessarily to scale, or in correct proportional relationships, which are not critical. Emphasis instead being placed upon clearly illustrating the principles of the invention such that persons skilled in the art will be able to make and use the 3D multilayered structures/techniques hereof, once they understand the principles of the subject matter disclosed herein. This invention may be provided in other specific forms and embodiments without departing from the essential characteristics described herein.

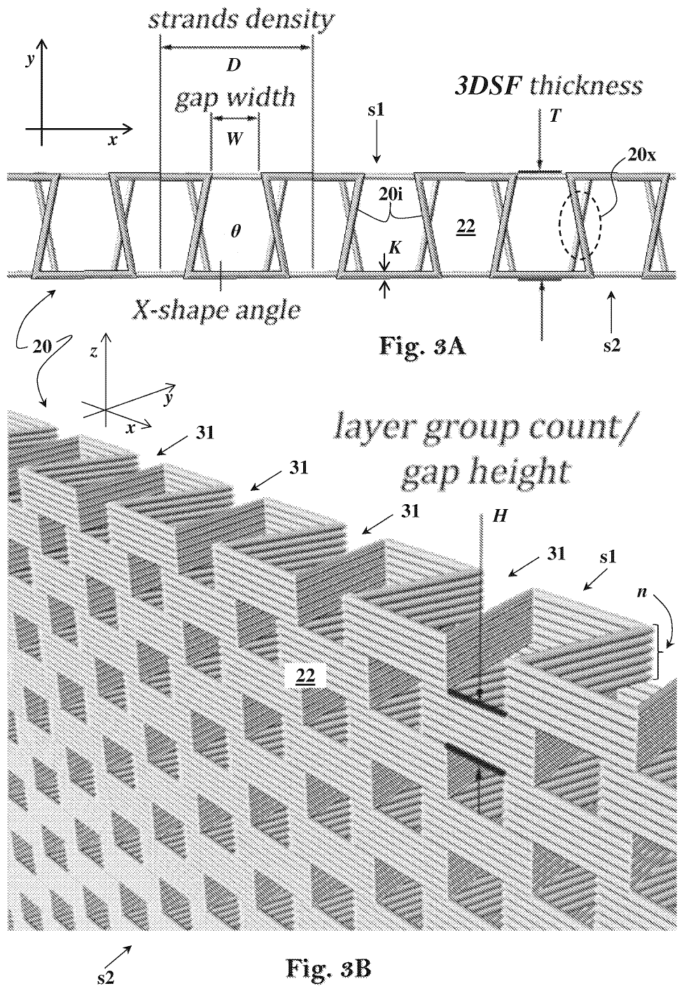

In embodiments herein the disclosed 3D multilayered structure construction is based on a single continuous path. The extrusion/printing path of the 3D multilayered structures disclosed herein can be of a zigzag/wavy shape, so as to form a straight line (20s) on one side of the multilayered structure and a gap/hole (20g) on the other side, (see FIG. 3). The zigzag path may be repeated on the z-axis (i.e., vertical/elevation) direction for one or more layers, and then flipped (i.e., 180° shifted along, or rotated about, the ‘x’-axis) for one or more layers. The flipping of the extruded/printed layer pattern generates a perforation pattern on each surface face of the 3D multilayered structure, as the alternate direction zigzagged layer pattern is extruded/printed in mid-air to close the gap/hole (20g) in the previously extruded/printed layer. The inner strands between the two surface faces (s1, s2) may also be printed in mid-air. The extruded/printed material is pulled between the faces (s1, s2) to form a fiber (20i) that is in a near orthogonal angle to the faces (s1, s2). Under compression, the inner strands (20i) buckle and fold similarly to the filler yarn in a conventionally knitted spacer fabric.

The alternation of the zigzag layer patterns causes the inner lines (20i) to cross each other and form X-shaped structures. The inner strands (20i) are connected only at the center of the X-shaped structures. This allows the inner shape to buckle and fold freely, providing compression properties to the material. By changing the geometry and extrusion/printing parameters, such as the amount of extrusion and/or the density of the inner strands, the stiffnesses of the final multilayered structure can be controlled. Another feature of the alternating zigzag layer path is a smooth surface on the faces (s1, s2) of the 3D multilayered structures. Since the 3D multilayered structures disclosed herein can be extruded/printed in one continuous path, there is no need for any start and stops points in the production process, and thus the 3D multilayered structure can be produced without any sharp edges or stringing i.e., the faces (s1,s2) feel smooth and soft when touched.

For an overview of several example features, process stages, and principles of the invention, the examples of 3D printing illustrated schematically and diagrammatically in the figures is intended for production spacer fabrics analogous structures (e.g., using g-code). These spacer fabrics analogous structures are shown as one example implementation that demonstrates a number of features, processes, and principles used for production of 3D layered/metamaterial structures, but they are also useful for other applications and can be made in different variations (e.g., using other 3D programming languages(s) or other extrusion, or pultrusion, techniques). Therefore, this description will proceed with reference to the shown examples, but with the understanding that the invention recited in the claims below can also be implemented in myriad other ways, once the principles are understood from the descriptions, explanations, and drawings herein. All such variations, as well as any other modifications apparent to one of ordinary skill in the art and useful in spacer fabric production may be suitably employed, and are intended to fall within the scope of this disclosure.

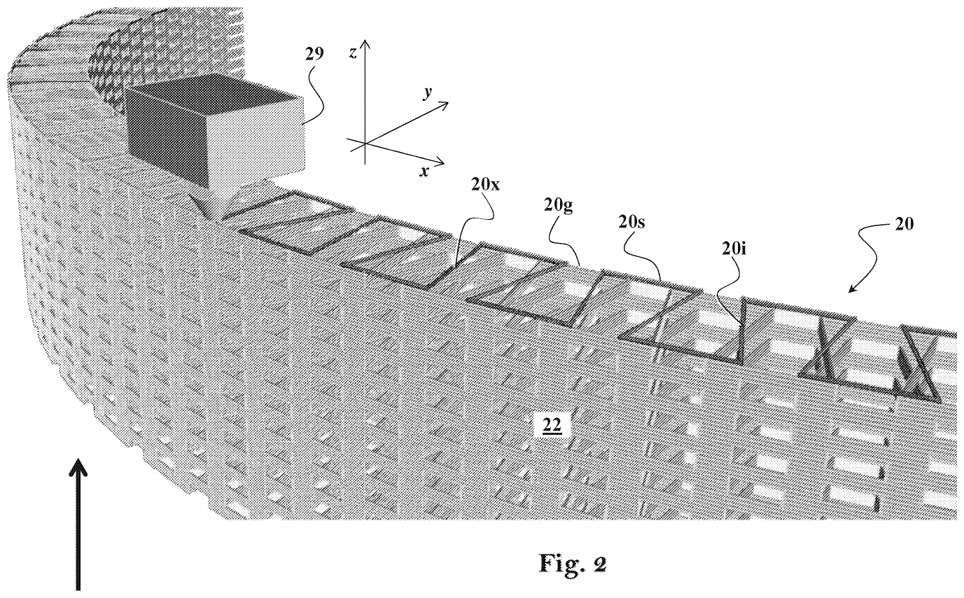

The construction of the 3D multilayered structures is based in some embodiments on a single continuous path printing approach. The printing path is carried out in a zigzagged layer pattern 20 in some embodiments. In some embodiments the zigzagged layer pattern includes straight lines 20s on one side and opposite gaps 20g on the other side, as exemplifies in FIGS. 2 and 3A. The zigzag layer pattern 20 can be repeated numerous times along the z-axis (i.e., vertical/elevation) direction for a few layers, and thereafter flipped in the ‘x-y’-plane for few other layers. The flipping of the layer pattern generates a perforation pattern on each surface face of the 3D multilayered structure, as the alternate direction zigzag layer pattern 20 is extruded/printed in mid-air to close the gap 20g formed in the previously extruded/printed layer. The inner strands 20i between the two surface faces (s1 and s2 in FIGS. 3A and 3B) may also be printed in mid-air. The printed material is pulled between the faces (s1, s2) to form a fiber that is in a near orthogonal angle to the faces (s1, s2).

Under compression, the inner strands 20i buckle and fold similarly to the filler yarn in a conventionally knitted spacer fabric. The alternation of the zigzagged layer pattern 20 causes the inner lines 20i to cross each other (due to the crossing of the zigzag toolpath) and form X-shaped patterns 20x, also referred to as X-shaped springs or compressible region, that can be configured to provide nonlinear stiffness. The inner strands 20i are preferably connected only at the centers of the X-shaped patterns 20x thereby formed. This allows the inner shape to buckle and fold freely, providing compression properties to the material. By changing the geometry and extruding/printing parameters of the 3D multilayered structures, such as the amount of extrusion or the density of the inner strands 20i, the stiffnesses of the 3D multilayered structure can be controlled. Another feature of the continuous alternating zigzagged layer pattern 20 is a smooth surface of the faces (s1, s2) of the 3D multilayered structure. Since in possible embodiments the extruding/printing path is continuous, such that there aren't any start and stops in the production process, there are no sharp edges or stringing, such that the faces of the 3D multilayered structures feel smooth and soft to hand touch.

### Fabrication Parameters

The zigzagged layer pattern 20 can be controlled parametrically to generate different properties in the 3D multilayered structure 22. FIGS. 3A and 3B respectively show top and perspective view illustrations of the different geometry parameters that are controllably adjusted/varied during production of the 3D multilayered structures. Additional details of these controllably adjusted/varied geometrical parameters, in some embodiments disclosed herein, are provided below:

### Strands Density

The spacer strands' density D is the number of strands that connect the two face surfaces s1, s2 per one centimeter. This value, along with the inclination angle θ value, affects the width W of the holes 31 (gaps 20g) on the surfaces' faces s1, s2. A high spacer density D value will result in a stiffer 3D multilayered structure, while a low spacer density value D will result in a softer 3D layered structure with un-even compression properties due to the enlarged gaps 31/20g obtained in result between the spacer strands.

### Inclination Angle

The inclination angle θ affects the compression properties of the 3D multilayered structure 22 (as discussed hereinbelow). The minimal and maximal inclination angle θ depends on the distance between the faces s1, s2 i.e., the thickness T of the 3D multilayered structure. The maximal inclination angle θ can be nearly 90°, but in possible embodiments it is smaller than 90°, so as to maintain an overlap of at least 0.8 mm between the flipped zigzagged layer patterns 20. The minimal inclination angle θ depends on the spacer strands' density D and on the thickness T of the 3D multilayered structure. When the inclination angle θ is minimized, the gaps (20g) on the surface faces s1, s2 of the 3D multilayered structure 22 are sealed.

### Gap Height

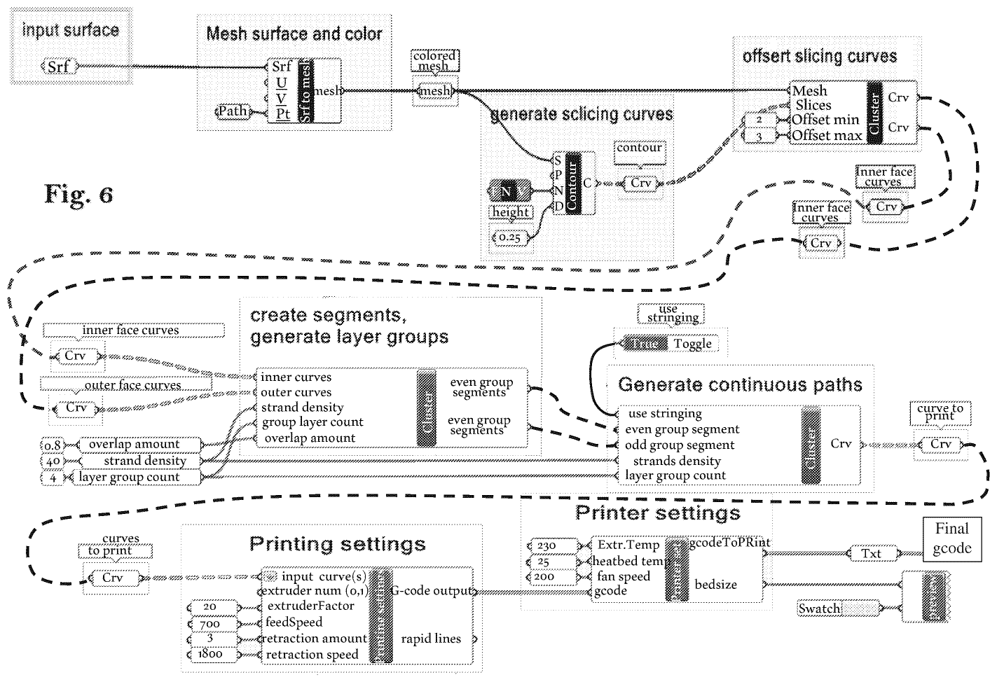

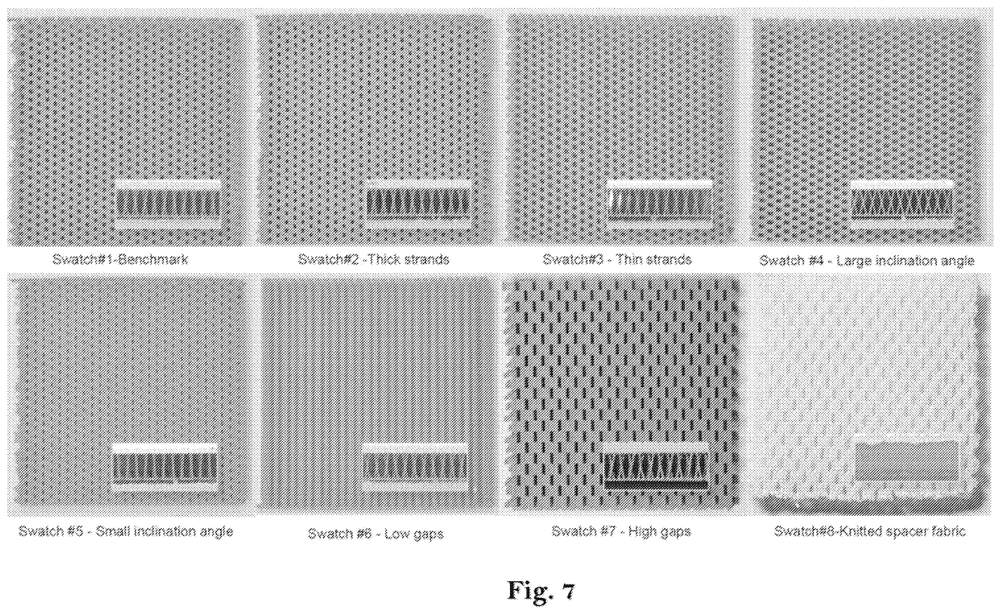

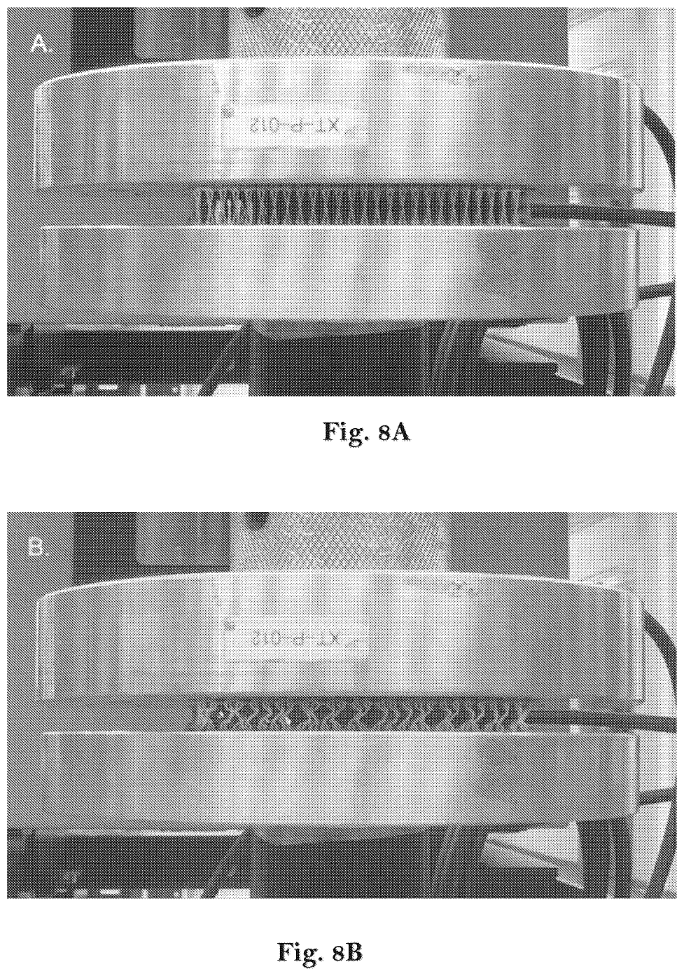

The gap's (i.e., holes 31) height H is determined by the number n (wherein n≥1 is a positive integer number) of layers in the same direction of the zigzagged layer pattern 20 e.g., in FIG. 3B n=6. Every time the zigzagged layer pattern flips, the holes 31 on the open side of the zigzag pattern are closed, and an alternating holes pattern is thereby formed. In possible embodiments the user can select the number of layers n between the flipping of the zigzagged layer pattern 20 i.e., the number n of unshifted, or shifted, layers stacked one top of the other. For example, in possible embodiments the selection of the number of the layers n between the flipping of the zigzagged layer pattern is done by changing the value of the layer group count number slider in the grasshopper user-interface (UI). The group layer count value can be low as one (n=1) for flipping the zigzagged layer pattern of each and every extruded/printed layer, which will form narrow holes 31 at the height of the slicing layer height. Greater values of the number of the layers n between the flipping of the zigzagged layer pattern can be selected to generate long and narrow holes 31, such as seen in FIG. 7.

### 3D Multilayered Structure Thickness

The thickness T of the 3D multilayered structure 22 can be set to be a constant value, or it may be varied within the x-z plane of the 3D multilayered structure 22. In some embodiments, in order to form a variable thickness T pattern, the user selects a grayscale image which pixels' values represents the desired thickness T in the x-z plane of the 3D multilayered structure 22 i.e., the pixels' values of the selected grayscale image are mapped to the input surface. Optionally, the user can also select the minimal and the maximal thickness values T to apply to the 3D multilayered structure 22. In possible embodiments a blurred grayscale image is used to set a desired variable thickness T pattern, that generates a smooth transition of thicknesses in the 3D multilayered structure 22.

### Extruding/Printing Parameters

### Strand Thickness

The thickness K of the strands of the 3D multilayered structure is controlled by the amount of material extruded by the 3D extruder/printer as it is extruding and pulling the material when moving between the surface faces s1, s2. The extrusion amount depends on the extrusion factor parameter that is selected by the user. The length of each segment can be divided by the extrusion factor to calculate the “E” value for the g-code commands. A low extrusion factor will create stiffer and heavier 3D multilayered structures 22, since the strands will be thicker.

Printing with Stringing

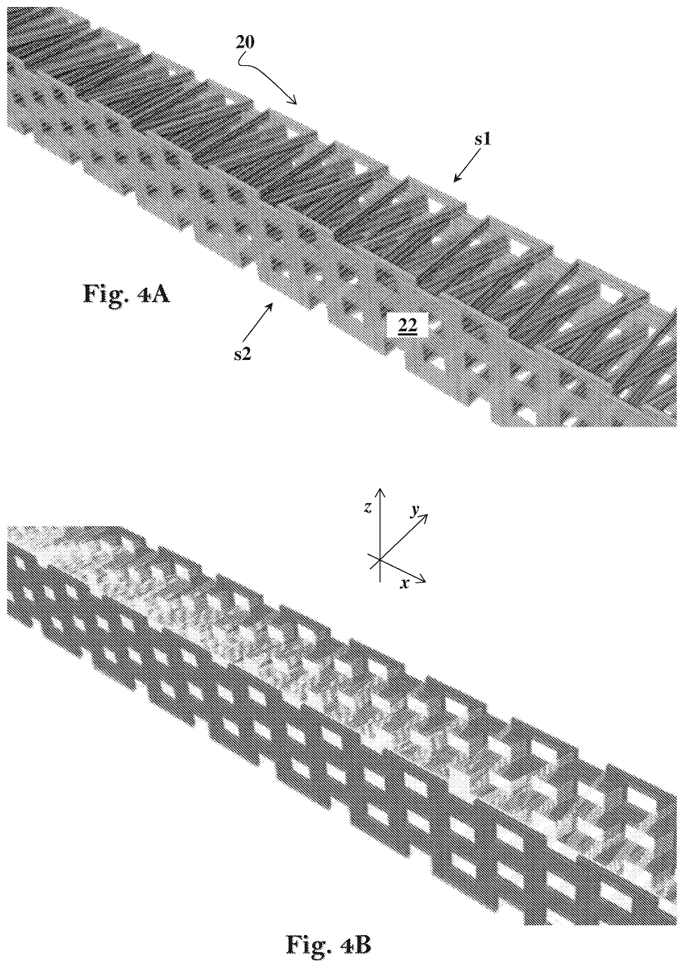

In order to generate ultra-thin strands, leveraging of oozing and stringing is performed in some embodiments. Oozing and stringing is usually an unwanted phenomenon that occurs, especially when using flexible filaments, such as TPU. Due to the viscosity of those materials, the pressure that remains inside the extrusion nozzle when going between paths causes strings to form. In possible embodiments the stringing is leveraged to create fine and thin filler strands. Embodiments disclosed herein allow the user to select between two production modes: (i) extruding/printing the inner strands 20i (see FIG. 4B); or (ii) skipping them (see FIG. 4B).

When skipping the inner strands 20i i.e., mode (ii) is selected, the 3D extruder is not instructed to extrude material while it is moved between the faces s1, s2 of the 3D multilayered structure 22. However, because of the existence of pressure residuals in the nozzle of the extruder (29), in practice, a thin strand is actually stretched and connects between the faces s1, s2 of the 3D multilayered structure 22 while the extruder is moved between the faces s1, s2 in mode (ii).

In order to create even thinner strands, retraction can be used. If retraction is used, the extruder's motor is rotated back to reduce the pressure inside the nozzle, which will cause less material to ooze, such that a thinner strand will be generated.

### 3D Multilayered Structure DESIGN

Manufacture techniques of 3D multilayered structure embodiments disclosed herein can be based on parametric slicing and g-code manipulation. In some embodiments a 3D multilayered structure design tool is built in Rhino/Grasshopper environment, wherein the user can control the toolpath geometry and printing parameters by interacting with a number of sliders and/or other user interface (UI) elements in the Grasshopper interface.

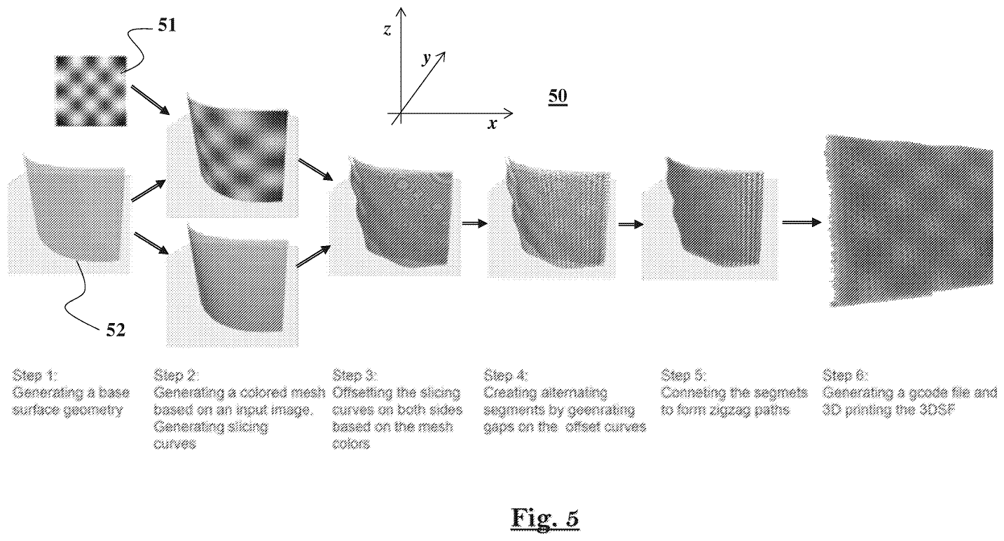

With reference to FIG. 5A, the 3D multilayered structure design process 50 starts in some embodiments by importing a shell surface geometry 52 (step 1). A simple geometry with little curvature may be used e.g., if the design tool doesn't include support structures, because high curvature might result in collisions of the toolpath.

The surface geometry is then changed into mesh geometry. To vary the thickness of the 3D multilayered structure, the user may select a grayscale image 51 that will be used to color the mesh (Step 2). The geometry is then sliced into layers by intersecting it with an array of planes parallel to the x-y plane at the layer height distance (H e.g., for a 0.4 mm nozzle a 0.25 mm layer height H may be used). The intersection of the geometry and array of planes generates the slicing curves (Step 2 bottom). The slicing curves are then offset to both sides (i.e., on they-axis, see Step 3), in accordance with the thickness value (T), to thereby define the faces (s1, s2) of the 3D multilayered structure (22). If a variable thickness of the 3D multilayered structure is required, the offsetting of the slicing curves is guided in accordance with pixel values of the grayscale image 51 selected for this purpose.

Next (step 4), the offset curves are divided into an equal number of segments. The number of segments can be controlled by the user e.g., in the UI by selecting the strand density (D). An alternating pattern is then applied to remove from the segmented curves the every-other segment from each side of the faces (s1, s2). This pattern alternates according to the layer group count value (Step 4). The remaining segments on both faces (s1, s2) are then extended by a defined value e.g., specified by the user. This extension of the remaining segments generates the inclination angle (θ) of the X-shapes (20x) between the faces (s1, s2) of the 3D multilayered structure (22). A minimal extension will result in a sharp angle and a short overlap between the layers. A long extension value will generate a longer overlap and a larger inclination angle (θ).

The process 50 then proceeds to connect (Step 5) the remaining segments to form the continuous curve of the zigzagged layer pattern (20). Particularly, an edge of a remaining segment (20s) is connected by a line (20i) to an adjacent edge of a remaining oppositely located segment (20s). The user can select in some embodiments the “print with stringing” option in the UI. In that case, the remaining segments will not be connected but will maintain an alternating printing sequence between the faces. The direction of the zigzagged layer pattern is flipped every-other layer to optimize the printing. This way, the printer's travel movements are minimized, to thereby ensure efficient and fast printing.

In some embodiments, after the toolpath curves are generated, they are fed into a Grasshopper cluster that generates g-code lines e.g., the X, Y, and Z values of the curves' control point are used to compose the g-code G1-movement lines, and the length of each segment is used to calculate the E values.

The last part is setting the printing parameters. This is done in some embodiments in an additional Grasshopper cluster. The user can determine the printing speed, nozzle, and bed temperatures and set the extrusion factor. The grasshopper cluster adds the g-code start and g-code end commands to compose the full g-code file, which is ready to be 3D printed (Step 6).

This way, the repeating X-shaped strand patterns (20x), in conjunction with multilayers, forms a spacer-fabric-like sheet. The 3D multilayered structure design process 50 can be accordingly used to produce spacer fabrics 22 in a variety of controlled thicknesses, patterns, and densities, within the same single fabric. It is also noted that the disclosed 3D multilayered structures/techniques are usually heavier than their conventional knitted spacer fabric counterparts (e.g., weight of a 80×80 mm 3D multilayered structure piece is typically in the range of 9.5-16.7 grams, compared to a 4.2 grams piece for standard SF). However, the 3D multilayered structures/techniques of the present application provide better compression properties.

### Compression Test

### Compression Tests Setup

For the compression test, seven 3D multilayered structure swatches were 3D printed and compared to a conventionally knitted spacer fabric of the same dimensions and same strand density (see FIG. 7). The filler yarn of the knitted spacer fabric was made of a 0.16 mm thick monofilament nylon yarn, and the two fabric faces were made of polyester yarns. The weight of each of the conventionally knitted swatches was 4.6 grams. The dimensions of the 3D-printed swatches were 80 mm by 80 mm with a thickness of 8 mm. All of the 3D-printed swatches were printed using similar parameters, except for a single parameter that was used to highlight a specific change compared to a benchmark swatch (Swatch #1). The printing and geometry parameters are specified in Table 1 hereinbelow.

The parameter that was changed in each of the 3D-printed swatches is highlighted in Table 1. All of the 3D-printed swatches were printed at 42 mm/sec feed speed, using a 0.25 mm layer height and with a strand density of 3.4 strands per centimeter. For Swatch #3, 3D-printing with stringing method was used. In this method (Swatch #3), the 3D-printer doesn't extrude materials when moving between the surface faces (s1, s2). As a result, there is also less material that is printed on the surface faces (s1, s2). To compensate for that, the extrusion factor was lowered in order to extrude more material at the faces (s1, s2), and retraction was not used at all. As a result, there is not a significant difference in weight compared to the benchmark swatch (Swatch #1). Nevertheless, the thickness of the strands is narrower, which affects the compression properties of the 3D multilayered structures, as seen in the results plots of FIG. 10, in which S1 designates Swatch #1 and S8 designates Swatch #8. The 3D-printing time of all of the swatches was similar, ranging from 50 to 52 minutes per swatch.

TABLE 1
Geometry and printing parameters used to create the 3D layered swatch structures.

| | | | | | | Physical properties | | |
|---|---|---|---|---|---|---|---|---|
| | | Geometry parameters | | Printing parameters | | | Strands | Gaps |
| | | Inclination | Layer | Extrusion | Printing | Weight | thickness | dimensions |
| # | Swatch name | angle | group count | factor | method | (grams) | (mm) | (mm) |
| 1 | Benchmark | 80 | 6 | 22 | Print strands | 9.7 | 0.28 | 1.4 × 1.6 |
| 2 | Thick strands | 80 | 6 | 16 | Print strands | 16.7 | 0.48 | 1.1 × 1.5 |
| 3 | Thin strands | 80 | 6 | 16 | Stringing | 9.5 | 0.22 | 1.6 × 1.6 |
| 4 | Large inclination | 75 | 6 | 22 | Print strands | 13 | 0.34 | 2.3 × 1.6 |
| | angle | | | | | | | |
| 5 | Small inclination | 85 | 6 | 22 | Print strands | 11.1 | 0.35 | 0.5 × 1.6 |
| | angle | | | | | | | |
| 6 | Low gaps | 80 | 1 | 22 | Print strands | 12.3 | 0.33 | 1.2 × 0.25 |
| 7 | High gaps | 80 | 15 | 22 | Print strands | 12.5 | 0.33 | 1.2 × 3.75 |

The compression test used an INSTRON Electroplus E10000 machine, equipped with two 150 mm plates, as defined by ASTM D 575 standard for test methods for rubber in compression. During the test, the top plates moved at a speed of 12 mm per minute up to deformation of about 60% of the initial thickness of the swatches. Each swatch was tested three times, and the average results are presented as strain-stress curves shown in FIGS. 10 to 13.

a. Compression Test Results

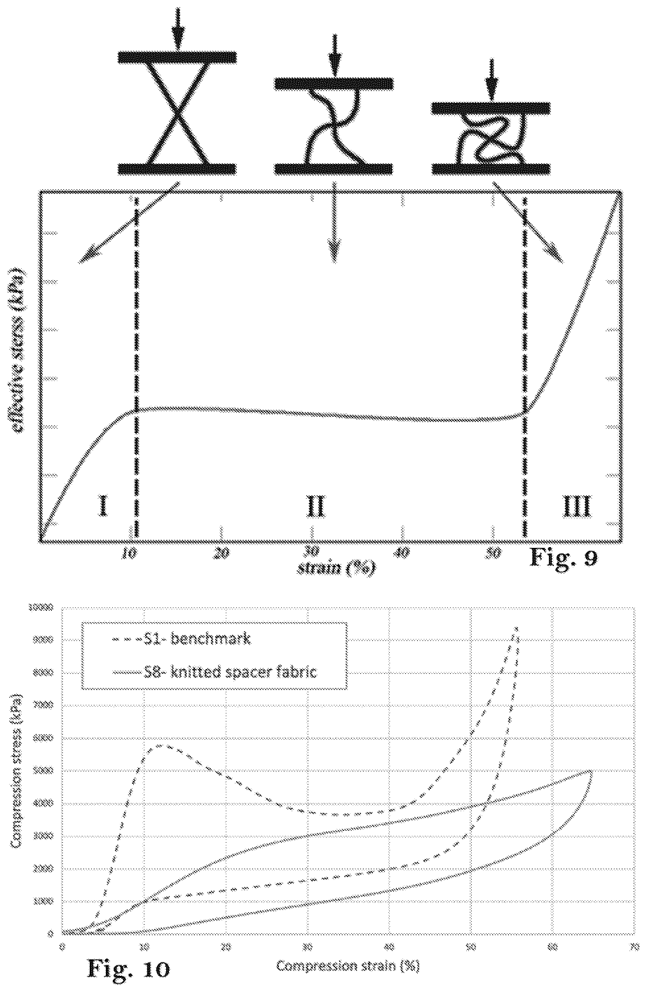

The results of the compression tests are presented using a series of strain-stress curves that illustrate the compression behaviours of the 3D layered swatch structures, and of the conventionally knitted spacer fabrics that were tested. The elastic modulus of each swatch is shown as the ratio between the force-induced per square centimeter and relative deformation. The results show similar characteristics to a typical X-spring that has previously been investigated by Bunyan et al. (see [7]), as shown in FIG. 9.

The compression behaviour is divided into three stages/phases. The initial stage/phase is approximately linear, as the material is compressed, but it is not buckled yet. The second stage/phase starts after the buckling starts to occur, which can be sudden or smooth, based on the geometry used. This stage/phase is characterized by flat stress plateau regime, which represents the essential nonlinear stiffness. In the third stage/phase, the material is completely buckled, and stiffening and densification occurs. This can be seen in a stiff inclination of the curve.

First, the conventionally knitted spacer fabric is compared with the benchmark Swatch #1 (see FIG. 10). The results show a difference in the compression behaviour between the 3D-printed and the conventionally knitted swatches. The deformation of the conventionally knitted swatch is moderate throughout the test. The filler yarns in the conventionally knitted spacer fabric are originally slightly bent because of the fabrication method. When force is applied, it causes the yarns to bend, hence the resistance to the force is minimal. In the 3D layered structures disclosed herein, on the other hand, the inner strands are nearly straight, therefore there is a need for a greater compression force to compress the 3D multilayered structures in the first phase. After 12% of strain, the strands start to buckle and fold (see FIG. 10), wherefrom the densification stage/phase starts. The force required for getting to a strain of 55% is greater. At this point, the compression was stopped in order to remain in the elastic stage/phase of the material and avoid entering the plastic stage/phase.

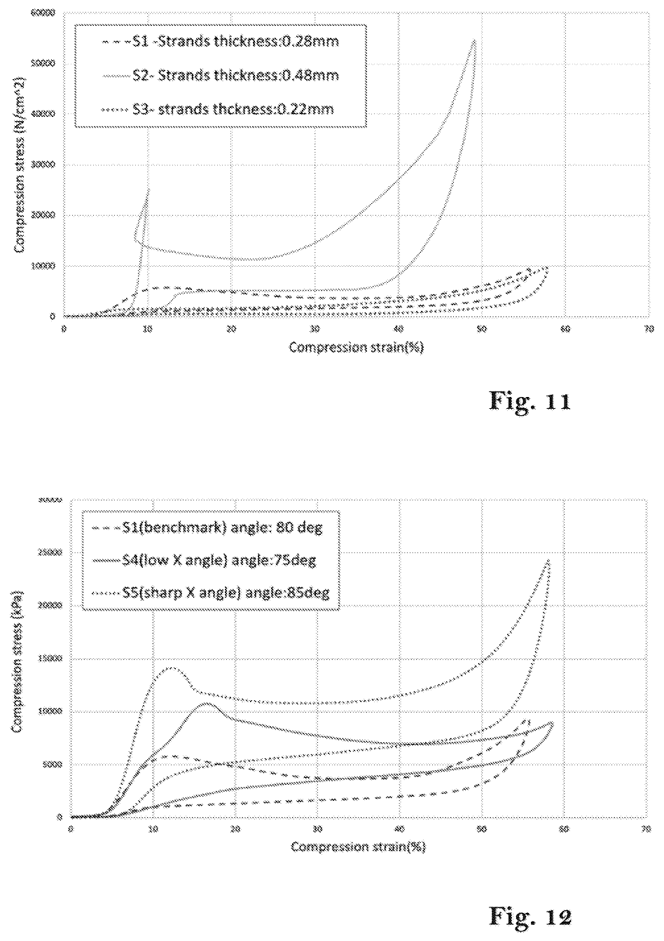

Next, the compression behaviour of swatches with different inner strands thicknesses were compare (see FIG. 11). Here a dramatic difference is observed between the swatches. Swatch #2 has thicker strands because of a different extrusion amount in the g-code file. The strands of this swatch are 71% thicker than the benchmark Swatch #1, however, the amount of force needs to compress the material is significantly larger. The thick strands resist compression until the strain reaches 10%, then the strands suddenly collapse, reducing the compression stress significantly. Because of the thickness of the strands, the densification stage/phase of the compression is longer and starts at a compression strain of 25%. In contrast, Swatch #3 with thinner strands has a compression behaviour that is similar to the conventionally knitted spacer fabric (see FIG. 9). Since the strands are thin, they don't resist the compression much, therefore the strain-stress curve slope is moderate and constant thought-out the test, except for a slight increase in the force at the initial strain. The densification stage/phase of Swatch #3 is similar to the densification of the benchmark Swatch #1.

As explained hereinabove, the inner strands (20i) of the 3D multilayered structures (22) disclosed herein generate an X-shaped patterns (20x) due to the 3D layered construction technique. Different inclination angles (θ) of the X-shaped patterns (20x) were tested to check how they affect the compression behaviour of the 3D multilayered structures (22). The inclination angle (θ) of the X shape affects the buckling of the material under compression as a result affect the compression properties.

The effect of the different inclination angles on the compression behaviours is shown in FIG. 12. Swatch #4 was designed with an inclination angle of 75°, and Swatch #5 with strands at an inclination angle of 85° degrees. The inclination angle of the benchmark Swatch #1 is 80° degrees. The result shows that more compression stress is needed for the same stress amount for both the larger inclination angle and the smaller inclination angle compared with the benchmark Swatch #1. The initial stress required before the buckling starts is greater for Swatch #5 since the almost perpendicular strands resist the compression more than the strands with lower angles. Because of the inclination angle, the strands are more separated, and therefore the compression stress is almost constant until the densification phase, which starts at a strain of about 45%. The strands of Swatch #4 buckle differently. The amount of force required for the initial buckling is greater than the force in the maximal strain. The initial buckling starts later in the test, at about 16% strain since the wider X-spring can deform before the bucking happens. The densification stage/phase starts only at a strain of 55% because the buckling of this swatch is symmetrical and less random.

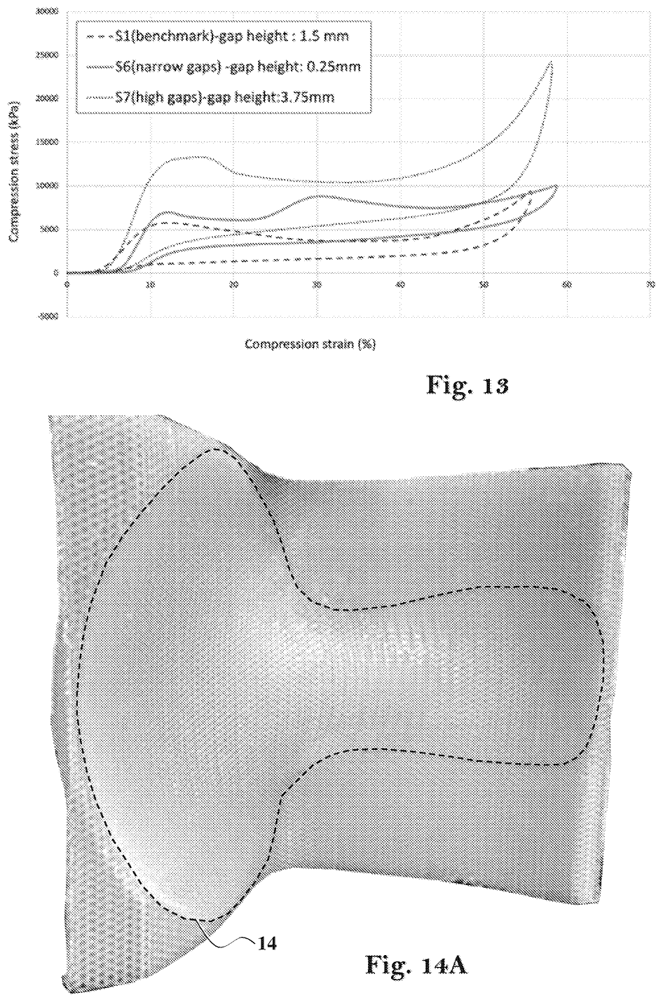

Lastly, the way the layer group count affects the elastic modulus of the 3D multilayered structures is compared. The layer group count affects the size of the holes (31) on the surface faces (s1, s2) of the 3D layer structure (22) and also affects the width of the inner strands. In Swatch #7, the layer group count parameter is 15. This means that the width of each inner strand is 3.75 mm (15 times the 0.25 mm layer height). In Swatch #6, the layer group count is n=1; which means that each strand is as wide as the layer height (H). FIG. 13 shows the results of the compression tests of these two 3D layered swathe structures compared with the benchmark Swatch #1, which has a group layer count value of n=6. The results show that Swatch #6 behaves differently than the other swatches. The reduction in the stress after the initial bucking is smaller, and another buckling happens at a strain of about 30%. The compression behaviour of Swatch #7 is similar to the behaviour of the other swatches, except for the initial buckling stage/phase, which is longer and happens between the strain of 10% to 20%. The compression stress of Swatch #7 is double almost thought-out the test compared to Swatch #6, meaning that the width of the strands increases the compression properties of the material.

### Potential Applications and Markets

The 3D layered structures disclosed herein can be used as spacer fabrics substitute, and may be used in production of sport (e.g., sportswear, accessories, safety gears) and/or fashion (e.g., clothes, bags, and other accessories) articles. For example, and without being limiting, the 3D multilayered structures disclosed herein can be used for architecture applications, automotive vehicles interiors, soft robotics, intimate apparels, protective equipment, sound adsorbate, cushioning and energy absorbent.

The 3D multilayered structures disclosed herein can be manufactured by most conventional 3D extruding/printing machinery and techniques, using curable materials as known in the art and/or as will be developed for use in the future. For example, 3D multilayered structures of embodiments hereof can be manufactures by conventional 3D extruding/printing machinery and techniques.

### EXAMPLES

### Riding Shorts

Professional bicycles used for road or off-road riding are equipped with a hard seat. Prolonged sitting on these seats while riding might cause pain, abrasions, and pressure sores to the cyclists. To deal with this problem, professional riders wear unique riding shorts that are padded in the buttocks and groin area. The padding helps to soften the body's encounter with the chair and allows cyclists to ride for hours without feeling pain and sores. The upholstery is usually made of gel or sponge (when the sponge is considered to be the higher quality upholstery) sewn to the pants. In this example, a cushion-shaped 3D multilayered structure was made for riding pants.

The 3D multilayered structures' energy absorption capacities of embodiments hereof softens the contact with the bicycle seat in the 3D layered cyclists' padding implementations that were tested. Unlike current solutions for padding, the 3D multilayered structure is breathable and allows for moisture and sweat ventilation. The 3D shape of the 3D multilayered structure was designed after a conversation with cyclists and an analysis of existing riding shorts in the market to provide comfort and match the body curvature. Since the silhouette 14 of the cushion is rounded, the 3DSF layered cyclists' padding structure was 3D-printed with a support structure that connected the desired shape (14) to the 3D-printed platform.

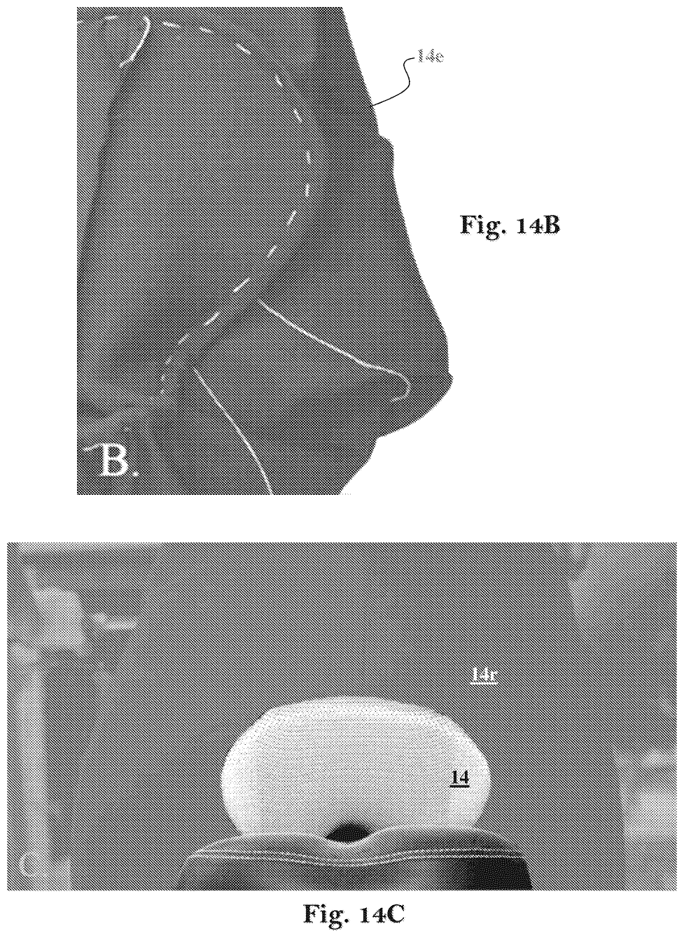

After printing, this support structure is cut away. Then, the cut 3D multilayered structure was manually sawn to the short's elastic fabric (14e in FIG. 14B). The riding shorts 14r prepared utilizing the 3D layered padding structure of embodiments hereof (shown in FIG. 14C) was successfully used and washed in a washing machine.

### Kneepad

Knee protective pads are usually produced by an assembly of different materials, comprising: (I) compressive material, usually foam, configured to absorb the energy of an impact; (II) soft material/fabric configured to be in direct physical contact with the user's body and provide flexibility and soft touch; and (III) a stiff material (e.g., plastic of metallic/still element) configured for protection and to resist abrasion. In addition, usually elastic straps are used to attach the knee pads to the user's body.

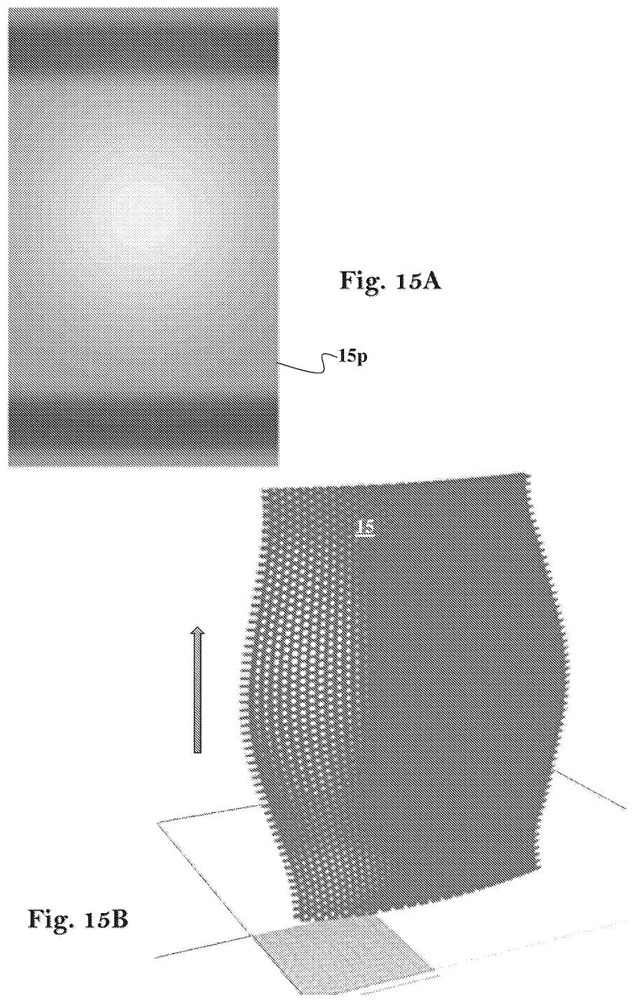

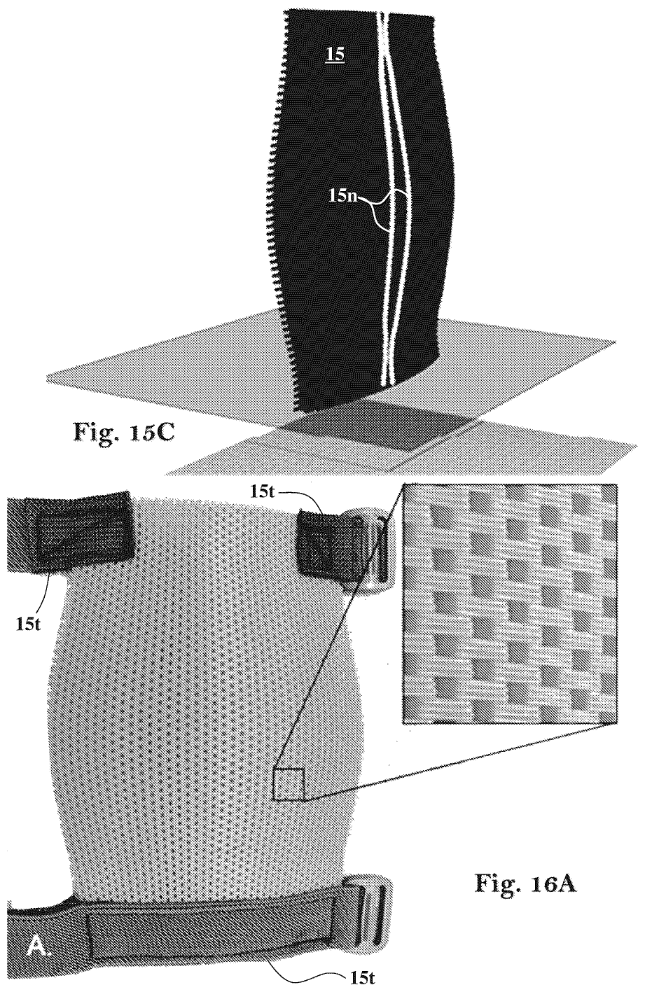

Here, 3D multilayered structures construction techniques of embodiments hereof were used to print a full kneepad 15 in a single piece, to include many of the above functionalities by varying the thickness of the 3D printed 3D layered pad structure 15. The kneepad 15 is 3D-printed upright in a standing position (e.g., bottom-to-top, as demonstrated in FIG. 15B). Since the bottom side of the piece 15 is flat, there is no need for any support structures. In order to provide more compression in the knee area, the 3D layered knee pad structure 15 is printed such that its middle/center area is thicker than its edges. The white line annotations 15n in FIG. 15C represent the variable cross session of the 3D layered knee pad structure 15.

In this non-limiting example, the thickness of the 3D layered kneepad structure 15 varies, from a thickness of about 10 mm in the middle of the pad to about 4 mm around the edges. The thicknesses of the top and bottom portions of the 3D layered kneepad structure 15 are narrower to alleviate the sewing of the straps 15t. The variable thickness is driven by a blurred grayscale image map (15p in FIG. 15A) that enables gradual transition of thicknesses. The variable thickness cross sections (lines 15n) of the 3D layered kneepad structure 15 can be seen in FIG. 15C.

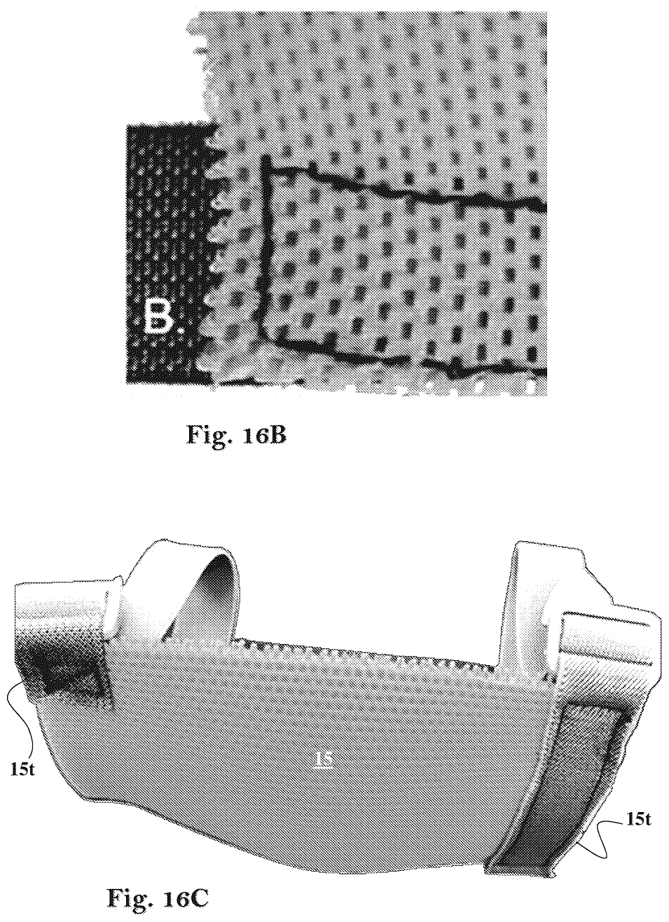

The fully printed 3D layered kneepad structure 15 according to possible embodiments is shown in FIGS. 16A and 16B. The geometry of the fully printed 3D layered kneepad structure 15 is slightly curved to conform to the shape of the knee (see FIG. 16C). The straps 15t are sawn to the 3D layered kneepad structure 15 using a standard industrial sewing machine using standard thread similar to sewing knitted spacer fabrics or foam (see FIG. 16B).

b. Insoles

Insoles are inserts for shoes that help with a variety of orthopedic conditions. Ideally, for best results, insoles need to match the foot of the person wearing the shoe and the shoe's geometry. Customizing and manufacturing a personalized insole is lengthy, expensive, and requires labor. For this reason, some solutions that are based on 3D scanning and 3D printing have emerged that for production of a digital workflow for production of personalized insoles. Usually, custom insoles are expensive, therefore, many people choose cheaper, mass-produced insoles that are not as effective as custom insoles and/or transfer insoles between shoes since it is costly to purchase insoles for each pair of shoes.

Existing 3D printed insoles are manufactured utilizing few 3D printing technologies. Each 3D printing technology has some advantages and limitations. Powder-based 3D printing (for example—selective laser sintering—SLS) enables the creation of complex geometries and porous lattice structures, however, it is an expensive technology in terms of machinery and costs of raw materials for printing and printers are usually massive in size. The printed material is rigid, and it is difficult to create cushioning and soft areas within the insole that are required for comfort and support for the foot. Moreover, this process requires significant post-processing, and therefore insoles printed in this technology are manufactured in remote fabrication facilities and require human labor.

Filament extrusion (for example, fused deposition Modeling—FDM) is another 3D printing technology used for 3D printing insoles. While the machinery and raw material are not as expensive and there isn't much post-processing involved, in current processes, the surface finish of the insoles is rough, which leads to inconvenience for the user. Also, printing time is long, and control over softness and cushioning are limited.

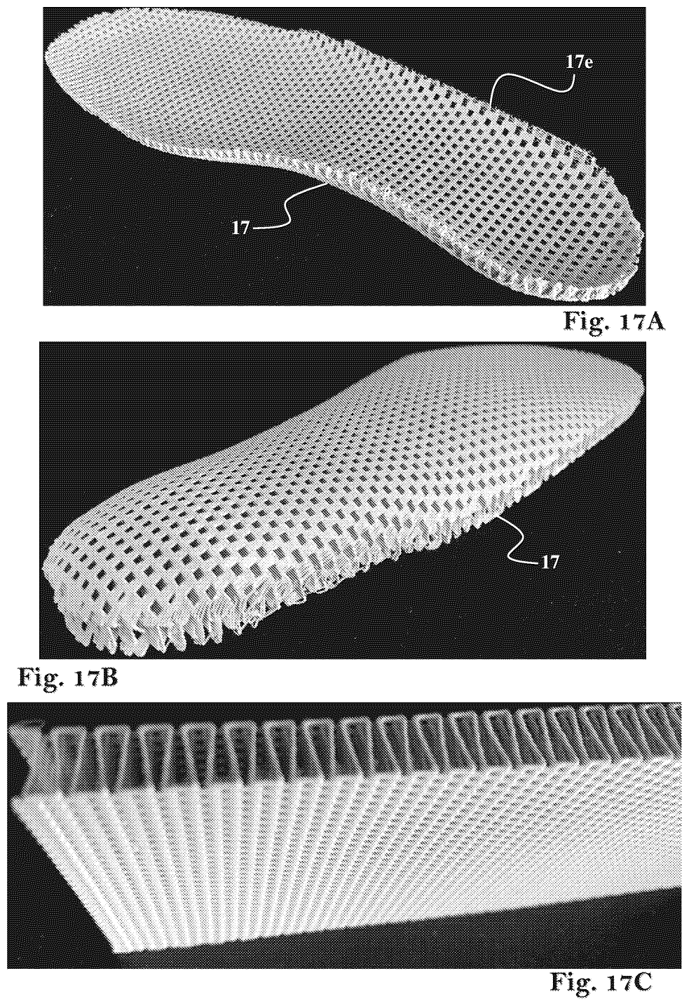

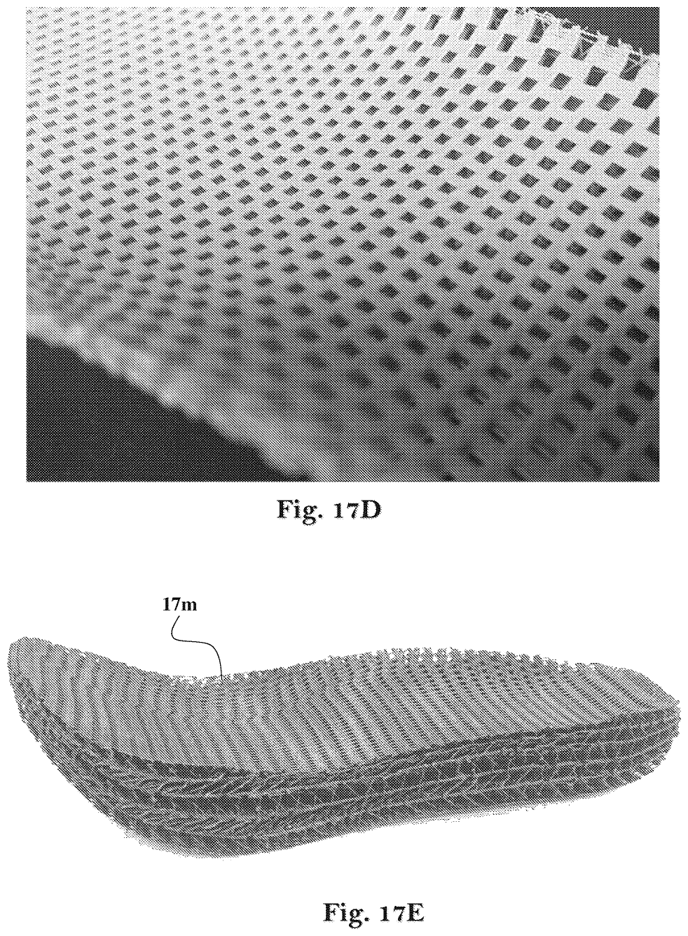

With reference to FIGS. 17A to 17E, the 3D layered based insole structures 17 according to embodiments hereof can be printed on the side (e.g., 17 in FIG. 17A). The 3D layered insole structures 17 cab be extruded/printed using the zigzagged layering pattern described hereinabove, that creates two smooth, porous surfaces on both sides of the 3D layered insole structure 17. In some embodiments, a middle layer (i.e., the compressible region 20x) of the 3D layered insole structure 17 is comprised of the the X-‘spring’ fibers printed in mid-air that provides enhanced cushioning and softness. This way, based on the user's foot parameters e.g., acquired by foot pressure scans, the design tool of embodiment hereof can be used to control the amount of stiffness and softness of the compressible region of the 3D layered insole structures 17, by adjusting the fiber's angle and/or thickness. This enables additional level of customization, in addition to the geometry of the 3D layered insoles structures 17.

The 3D multilayered structure manufacture techniques disclosed herein can be used to rapidly produce customized 3D layered insoles structures 17, that will be cheaper and faster to print than alternative 3D printed custom insoles available on the market nowadays. Since the 3D layer structures machinery is not expensive, and is relatively small in size, and only minimal post processing is required, the 3D layered insoles structures 17 of embodiments hereof can be printed on the spot in orthopedic clinics—compared with existing solution that are printed in manufacturing facility and takes several days to produce. FIGS. 17A to 17D show various views of 3D layered insoles structures 17 fabricated in accordance with embodiments of the present application. FIG. 17E shows a midsole fabricated in accordance with embodiments of the present application.

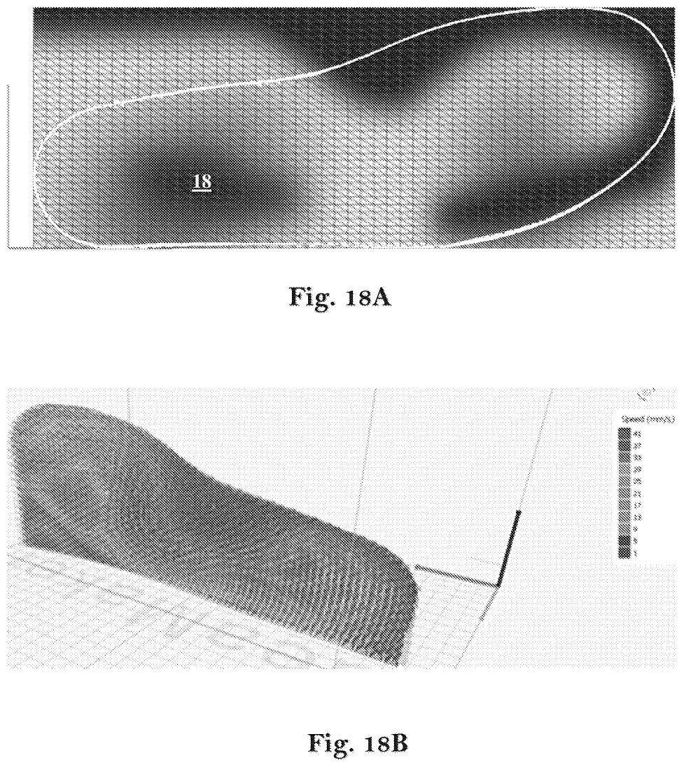

FIGS. 18A and 18B demonstrate an insole production process of possible embodiments. FIG. 18A shows foot surface data 18 acquired for a specific user, indicative of one or more parameters (e.g., pressure, height) associated with foot surface contour of the user. In this non-limiting example the surface data 18 is acquired by a pressure scan instrument (e.g., foot insole sensor system, such as Tactilus of sensor products inc.) configured to provide surface data 18 indicative of different pressure levels measured at a plurality of points of the foot surface of a user in an upright standing position. In this non-limiting example the surface data 18 is presented as a grayscale image wherein dark regions represent low pressure areas and light regions represent high pressure areas. Alternatively, or additionally, the surface data 18 can include 3D foot surface contour data e.g., acquired by a 3D scanner.

The acquired surface data 18 can be then used to generate stiffness and/or thickness data by determining for each region of the surface data 18a a stiffness level desired for the respective region of the 3D layered insole structure (17) to be manufactured for the user. The stiffness data is used in some embodiments to generate production tool instructions data for producing a 3D layered insole structure (17) matching the user's specific requirements based of the determined stiffness data. For example, the production tool instructions data comprises in some embodiments nozzle speed and/or extrusion amount instructions for each draw of material in each layer (20) of the 3D layered insole structure (17).

c. Bra

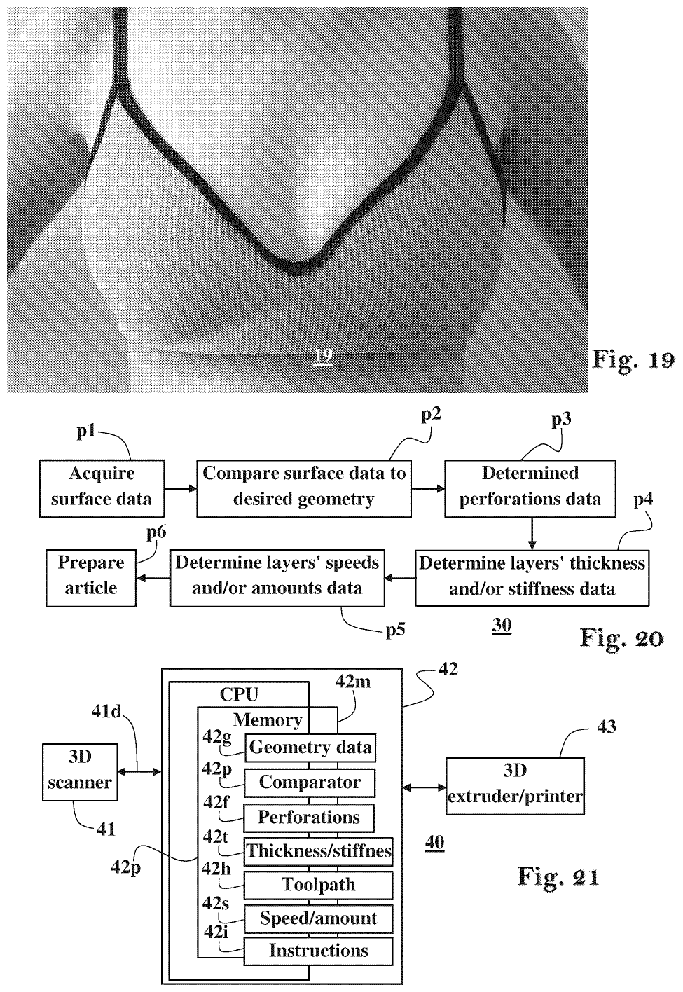

FIG. 19 shows a 3D layered bra 19 manufactured utilizing 3D multilayered structure production techniques according to embodiments of the present application. Embodiments of the present invention are used for determining thicknesses profile of the 3D layered bra 19 for adjusting it to users having uneven/asymmetric breasts (e.g., caused due to mastectomy) i.e., instead of a breast prosthesis. This is achieved in some embodiments by acquiring 3D breasts contour data (e.g., by 3D scanner) the user's breasts, comparing the acquired the 3D breasts contour data to a desired bra geometry. Thicknesses data for regions of each cup of the 3D layered bra 19 can be than determined based on the 3D breasts contour data and/or the comparison to the desired bra geometry. The determined thicknesses data can be then used to determine toolpath and/or tool production instructions for each draw of material along the extrusion/print path of each layer (20) of the 3D layered bra 19.

FIG. 20 is a flowchart demonstrating a 3D multilayered structure production process 30 according to possible embodiments, useful for fitting a 3D multilayered structure to a target surface area (e.g., a body part, such as, but not limited to, foot surface, breast, knee, shoulder, face, or suchlike). The production process 30 can start in step p1 wherein 3D surface data associated with the target surface area is acquired. The 3D surface data can comprise a contour/elevations map (e.g., acquire by a 3D scanner) indicative of the geometry of the target surface area, and/or a pressure map (e.g., acquire by a pressure scanner) indicative of a weight/load distribution thereover.

Next, in optional step p2, the acquired surface data is compared to a desired geometry/shape (e.g., bra cups) of the 3D multilayered structure. In step p3, properties of the perforations/holes (31 e.g., eight H and/or width n) can be determined at least partially based on the acquired surface data and/or the comparison of step p2. Additionally or alternatively, the properties of the perforations/holes are determined in step p3 based on geometry data and/or product's specifications data e.g., received from input device or memory storage.

In step p4 thickness and/or stiffness data is determined based at least in part on the acquired surface data and/or the comparison of step p2 and/or the perforations data determined in step p3 and/or the geometry and/or product's specifications data. The determined thickness and/or stiffness data comprises in some embodiments data indicative of a desired thickness and/or stiffness of one or more regions of the 3D multilayered structure. The determined thickness and/or stiffness data can be used in step p5 to determine speed and/or material draw amount data required for each draw of material along each of the layers (20) of the 3D multilayered structure to be manufactures. In step p6 the speed and/or material draw amount data can be used to generate the production tool instructions (e.g., g-code) for manufacturing the required 3D multilayered structure, which can be then used to prepare the same.

FIG. 21 schematically illustrates a 3D multilayered structures production system 40 according to possible embodiments, comprising a 3D extrusion/printing system 43 and a computer system 42 comprising one or more processors 42p and memories 42 configured and operable to determine extrusion/print instructions (42i) based at least partially on geometry data (42g) of a desired 3D multilayered structure to be thereby produced. Optionally, but in some embodiments preferably, the system 40 comprises a 3D scanner (e.g., surface contour mapper and/or surface pressure/weight/load scanner) 41 configured to generate surface data 41d of a target surface area to which the 3D multilayered structure should fit. The computer system 42 can be accordingly configured to determine the extrusion/print instructions (42i) based at least partially on the geometry data (42g) and/or the surface data 41d from the 3D scanner 41.

The computer system 42 comprises in some embodiments one or more of the following modules: a geometry data module 42g configured and operable to generate (e.g., based on products' specifications data) or acquire (e.g., via a data input interface/device—not show) geometry data desired for the 3D multilayered structure to be manufactured by the system; a comparator module 42p configured and operable to compare between the surface data 41d from the 3D scanner 41 and the geometry data from the geometry data module 42g; a perforations module 42f configured and operable to determine properties (e.g., height H, thickness n) of the perforations (31) of the 3D multilayered structure to be manufactured based at least partially on the comparison made by the comparator module 42p and/or the surface data 41d from the 3D scanner 41 and/or the products' specifications data; a thickness/stiffness module 42t configured and operable to determine thickness and/or stiffness data for regions of the 3D multilayered structure to be manufactured based at least partially on the comparison made by the comparator module 42p and/or the surface data 41d from the 3D scanner 41 and/or the products' specifications data and/or the perforations' properties determined by the perforations module 42f; a toolpath module 42h configured and operable to determine continuous/uninterrupted trajectory data of an extrusion/print nozzle of the 3D extrusion/printing system 43 based at least partially on the comparison made by the comparator module 42p and/or the surface data 41d from the 3D scanner 41 and/or the products' specifications data and/or the perforations' properties determined by the perforations module 42f and/or the thickness and/or stiffness data from the thickness/stiffness module 42t; a speed/amount module 42s configured and operable to determine nozzle speeds and/or amounts of materials data thereby extruded for each draw of material in each extruded/printed layer (20) of the 3D multilayered structure to be manufactures based at least partially on the comparison made by the comparator module 42p and/or the surface data 41d from the 3D scanner 41 and/or the products' specifications data and/or the perforations' properties determined by the perforations module 42f and/or the thickness and/or stiffness data from the thickness/stiffness module 42t and/or the trajectory data from the toolpath module 42h; and/or a production tool instructions module 42i configured and operable to generate instructions (e.g., g-code) for operating the 3D extrusion/printing system 43 for fabricating the 3D multilayered structure based at least partially on the comparison made by the comparator module 42p and/or the surface data 41d from the 3D scanner 41 and/or the products' specifications data and/or the perforations' properties determined by the perforations module 42f and/or the thickness and/or stiffness data from the thickness/stiffness module 42t and/or the trajectory data from the toolpath module 42h and/or the nozzle speeds and/or amounts data from the speed/amount module 42s.

### Spacer Fabrics

The 3D multilayered structures disclosed herein and the conventionally knitted spacer fabrics have similar structural elements: two perforated surface faces (s1, s2) that are connected with orthogonal, or nearly orthogonal, inner strands. One of the differences between these spacer fabrics is in the ability to combine different materials and patterns in each layer (20) of the 3D multilayered structures disclose herein. The surface fabrics of conventional knitted spacers are knitted independently and separately from each other and the filler yarn. Each fabric face (s1, s2) can have a different knitted pattern, with or without holes. Also, the material used for each face and filler yarns can be different.

For 3D multilayered structure hereof, however, the inner strands (20i) and surface faces (s1, s2) are printed using the same extrusion/print material, and the inner strands' (20i) architecture affects the perforations (31) pattern. For example, less dense inner strands (20i) will result in wider perforation gaps (31). Another major limitation and difference is in the fabrication speed. The 3D multilayered structures disclosed herein can be printed relatively fast compared to standard 3D printing, due to the optimized continuous/uninterrupted toolpath of the extrusion/print nozzle. However, the conventional knitted spacer fabrics are produced faster since they are typically made using large industrial machines that are designed for high throughput manufacturing.

The 3D multilayered structures disclosed herein can be printed to assume a desired three-dimensional shape, as illustrated in the riding shorts example shown in FIGS. 14A to 14C. Unlike the conventional knitted spacer fabric, that is manufactures in a form of flat spacer sheets. Since in the 3D multilayered structured disclosed are printed without support structures, there is a limitation on the possible slope of the geometries that can be printed. Slopes that are larger than 45° (degrees) might fail. Additionally, although the 3D multilayered structures disclosed herein are produced using an additive process, in case a curved silhouette is needed, the desired shape can be extended to touch the printer's build platform. This excess material needs to be cut and removed after printing.

### CONCLUSION AND DISCUSSION

New slicing technique and a design tool are disclosed herein for producing 3D layered metamaterials structures that are inspired by conventional knitted spacer fabric and that have similar construction. The 3D multilayered structure is created by generating a zigzagged toolpath directly from the design tool, bypassing the standard use of slicing software, thus enabling full control over the toolpath and extrusion/printing parameters, such as extrusion and retraction/material amounts. The various geometry parameters for controlling the appearance and functionality of the 3D multilayered structures were specified. Also presented herein, a concept for functional printing using stringing and oozing to generate ultra-thin strands.

The 3D multilayered structures disclosed herein contains X-shaped springs (20x) geometry formed between the flipped zigzagged toolpaths. In previous studies, X-shape springs geometry has shown similar compression properties compared to foamed materials and honeycomb lattice structures; therefore, it is suitable for energy absorption applications. A series of compression tests been conducted, that showed similar compression behaviour as typical X-spring. The tests results show that changing geometry and printing parameters affect the compression behaviour of the 3D multilayered structures of embodiments hereof. Lastly, case studies of bicycle riding shorts with a 3D layered padding structure that is formed to fit the body curvature, and a 3D layered printed kneepad and bra structures, were demonstrated.

The 3D layered structures disclosed herein provide a breathable, lightweight, and functional material that may be fabricated using low-cost desktop 3D printers. Its fabrication methods enable tuning the mechanical properties and shape of the final 3D multilayered structure thereby produced. The 3D multilayered structures disclose herein can be used as a substitute for foam and the conventional knitted spacer fabrics, and/or for prototyping purposes. It can also be used as a functional part in small quantities production. In addition, it can be used for customizing wearable products that require variable stiffnesses and ventilation.

Feature of the 3D multilayered structures production techniques disclose herein can be realized as computer executable code created using a structured programming language (e.g., C), an object oriented programming language, such as C++, or any other high-level or low-level programming language (including assembly languages, hardware description languages, and database programming languages and technologies) that may be stored, compiled or interpreted to run on computer devices, as well as heterogeneous combinations of processors, processor architectures, or combinations of different hardware and software. The processing may be distributed across a number of computerized devices, which may be functionally integrated into a dedicated standalone 3D multilayered structures production system. All such permutations and combinations are intended to fall within the scope of the present disclosure.

Each block in the diagrams shown in the figures may represent a module, segment, function, and/or a portion of an operation or step. One or more of these blocks may be implemented as program code, in hardware, or as a combination of the two. When implemented in hardware, the hardware may, for example, take the form of integrated circuits that are manufactured or configured to perform one or more operations in the flowcharts/block diagrams. In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram.

Those skilled in the art will understand and appreciate that the depicted methods/processes may alternatively, or additionally, be illustrated as a series of interrelated states via a state diagram and/or events that can be implemented by a state machine. Additionally, or alternatively, the methods disclosed herein can be stored on an article of manufacture e.g., program instructions and/or data stored on storage media and executable by a computer device, to facilitate implement of the method by computing devices.

As described hereinabove and shown in the figures, the present application provides 3DSF structures and related production methods. While particular embodiments of the disclosed subject matter have been described, it will be understood, however, that the disclosed subject matter is not limited thereto, since modifications may be made by those skilled in the art, particularly in light of the foregoing teachings. As will be appreciated by the skilled person, the subject matter disclosed herein can be carried out in a great variety of ways, employing more than one technique from those described above, all without exceeding the scope of the claims.

1-36. (canceled)

37. A multilayered structure comprising an alternating stack of one or more wavy layer patterns and one or more flipped wavy layer patterns stacked one on top of the other, to thereby form between anterior and posterior sides of said multilayered structure a plurality of “X”-shaped connections and a plurality of holes in anterior and posterior sides of said multilayered structure.

38. The multilayered structure of claim 37 wherein the wavy layer patterns are configured to form a plurality of connections between adjacently located pairs of the wavy layer patterns and of the flipped wavy layer patterns, at said anterior and posterior sides of said multilayered structure.

39. The multilayered structure of claim 37 wherein each of the plurality of wavy layer patterns is formed by a concatenation of a plurality of alternating trapezoidal patterns configured for forming the plurality of holes at a small base of said trapezoidal patterns.

40. The multilayered structure of claim 39 having varying inclination angles, and/or lengths, of legs of said alternating trapezoidal structures with respect to bases thereof.

41. The multilayered structure of claim 37 having a varying peak-to-peak difference of the wavy layer patterns, thereby defining a varying thickness of said multilayered structure.

42. The multilayered structure of claim 41 wherein the varying thickness is defined according to pixels values of a grayscale image.

43. The multilayered structure of claim 37 wherein the one or more wavy layer patterns and the one or more flipped wavy layer patterns are formed by at least one of the following: a continuous uninterrupted draw of material; extrusion or pultrusion; a 3D printer.

44. The multilayered structure of claim 37 configured: such that the one or more wavy layer patterns and the one or more flipped wavy layer patterns are configured to provide multiple densities of said wavy layer patterns and/or stiffnesses of said multilayered structure thereacross; and/or as a spacer fabric.

45. The system for preparing the multilayered structure of claim 37 comprising a 3D extruder or printer and a computer system comprising one or more processors and memories configured to generate instructions for operating said 3D extruder or printer for preparing said multilayered structure based at least in part on one or more of the following: surface geometry data; product's specifications data; thickness data; and/or stiffness data.

46. The system of claim 45 comprising a 3D scanner configured to generate surface data of a target surface area to which the multilayered structure is configured to fit.

47. The system of claim 45 comprising one or more of the following modules: a geometry data module configured to determine geometry data of the multilayered structure based at least partially on the product's specifications data; a comparator module configured to compare between the surface data from the 3D scanner and the geometry data from the geometry data module and generate comparison data indicative thereof; a perforation module configured to determine holes' properties data of the plurality of holes based at least partially on the comparison data from the comparator module, the geometry data from the geometry data module, the surface data from the 3D scanner, and/or the products' specifications data; a thickness/stiffness module configured to determine thickness/stiffness properties data of regions of the multilayered structure based at least partially on the comparison data from the comparator module, the geometry data from the geometry data module, the surface data from the 3D scanner, the products' specifications data, and/or the holes' properties data from the perforation module; a toolpath module configured to determine trajectory data of an extrusion/print nozzle of the 3D extrusion/printing system based at least partially on the comparison data from the comparator module, the geometry data from the geometry data module, the surface data from the 3D scanner, the products' specifications data, the holes' properties data from the perforation module, and/or the thickness/stiffness properties data from the thickness/stiffness module; a speed amount module configured to determine nozzle speeds data and/or amounts of materials data for each draw of material the one or more wavy layer patterns and the one or more flipped wavy layer patterns of the 3D multilayered structure based at least partially on the comparison data from the comparator module, the geometry data from the geometry data module, the surface data from the 3D scanner, the products' specifications data, the holes' properties data from the perforation module, the thickness/stiffness properties data from the thickness/stiffness module, and/or toolpath module configured to determine trajectory data; a production tool instructions module configured to generate instructions data for operating the 3D extrusion/printing system for fabricating the multilayered structure based at least partially on the comparison data from the comparator module, the geometry data from the geometry data module, the surface data from the 3D scanner, the products' specifications data, the holes' properties data from the perforation module, the thickness/stiffness properties data from the thickness/stiffness module, toolpath module configured to determine trajectory data, and/or the speeds data and/or amounts of materials from the data speed amount module.

48. A method for forming a spacer fabric analogous structure, the method comprising: defining a plurality of curves along a desired mesh geometry; offsetting a copy of said plurality of curves a predefined distance and removing segments of the plurality of curves and their offset copy to form alternating gaps therein; manipulating remaining segments of said curves and adding connection lines for connecting each edge of said segments with an adjacently located edge of a nearby and oppositely located segment, to thereby form a plurality of wavy layer patterns; and generating instruction for a 3D extruder or printer for drawing a curable material accordingly to form said plurality of wavy layers for fabrication of said spacer fabric analogous structure.

49. The method of claim 48 comprising forming X-shaped connection areas between the connection lines of adjacently located wavy layer patterns.

50. The method according to claim 49 comprising selecting between the following extrusion or printing modes: (i) forming the connection lines by nozzle movement with active printing operation; or (ii) forming said connection lines by nozzle movement by oozing and/or stringing.

51. The method according to claim 48 comprising selecting a base surface geometry and generating the desired mesh geometry from the selected base surface geometry.

52. The method according to claim 48 comprising one or both of the following: coloring the mesh geometry to define variable offset distances between the plurality of curves and their offset copy; and preparing a grayscale image for the coloring of the mesh geometry for defining the variable distances between the offset curves; intersecting the mesh geometry with a plurality of parallel planes for the defining of the curves.

53. The method according to claim 48 comprising segmenting each of the curves into an equal number of segments, and alternatingly removing segments in each curve to from the alternating gaps therein and define height of said gaps.

54. The method according to claim 48 wherein the manipulation of the remaining segments comprises extending at least some of said remaining segments with or without a desired inclination angle of the connection lines.

55. The method according to claim 48 comprising one or both of the following: setting the number of segments in each curve in accordance with a predefined strand density value of the spacer fabric analogous structure; and generating the desired mesh geometry based on a 3D scan of a target surface area.

56. The method according to claim 55 wherein the 3D scan of the target surface area comprises one or both of the following: a 3D contour surface scan; and a measure of pressures, weights and/or loads, distributed over the target surface area.
